(19) United States
(12) Patent Application Publication
(10) Pub. No.: US 2010/0195313 A1
(43) Pub. Date: Aug. 5, 2010

(54) LIGHT-DIFFUSING FILM AND APPARATUS PROVIDED WITH THE SAME

(76) Inventors: Masanori Hiraishi, Hyogo (JP); Satoshi Suda, Hyogo (JP); Hiroyoshi Kojima, Hyogo (JP); Yoshiki Yakushijin, Hyogo (JP)

Correspondence Address: BIRCH STEWART KOLASCH & BIRCH, PO BOX 747, FALLS CHURCH, VA, 22040-0747, US

(21) Appl. No.: 12/668,824

(22) PCT Filed: Jul. 18, 2008
(86) PCT No.: PCT/JP2008/063005

§ 371 Date: Jan. 12, 2010

(30) Foreign Application Priority Data
Aug. 2, 2007 (JP) 2007202129
Dec. 26, 2007 (JP) 2007 335076

(51) Int. Cl. G02B 5/02; B32B 5/16; B32B 27/36; B32B 5/00; C08L 69/00; F21V 9/06; G02B 1/10; G09F 13/04

(52) U.S. Cl. 362/97.1; 428/327; 428/412; 428/220; 525/146; 524/508; 252/589; 359/599

(57) ABSTRACT

A light-diffusing film comprises a light-diffusing layer (e.g., an anisotropic light-diffusing layer), and the light-diffusing layer comprises a continuous phase comprising a polycarbonate-series resin (a polycarbonate-series resin having a number average molecular weight of 15000 to 25000) and a dispersed phase comprising a polypropylene-series resin (a metallocene-catalyzed polypropylene-series random copolymer). A transparent layer may be laminated on at least one side of the light-diffusing layer. The light-diffusing layer may substantially be free from a compatibilizing agent. In spite of a use of the polycarbonate-series resin, the dispersed phase can uniformly be formed. Therefore, the film is suitable for a member of a plane light source device or a display apparatus. The light-diffusing film inhibits a change in a light-diffusing characteristic even under a high temperature.

### TECHNICAL FIELD

The present invention relates to a light-diffusing film for diffusing a transmitted light isotropically or anisotropically, a plane (or flat) light source device, and a display apparatus (e.g., a liquid crystal display apparatus).

### BACKGROUND ART

A backlight type display apparatus (e.g., a liquid crystal display apparatus), in which a display panel (e.g., a liquid crystal display module) is illuminated from a backside thereof, has a plane or flat light source unit (or a backlight unit) disposed on the backside of the display panel. Moreover, a diffusing sheet (or a diffusion sheet), a prism sheet, a sheet for improving luminance (e.g., a reflective polarizing plate) or the like is employed in order to uniformize an irradiated light to the display panel as a plane or flat light source and improve the luminance (or brightness) in the front side of a liquid crystal display apparatus. Further, in a liquid crystal display apparatus, a polarizing plate, a phase plate, a color filter, or the like is also used as a constituent member of a liquid crystal cell.

More specifically, for example, as a plane or flat display apparatus of which the image display area has a flat surface (a flat type display apparatus), an apparatus as illustrated in FIG. 1 is known. The apparatus comprises a plane or flat display unit (e.g., a transmissive (or transmittable) liquid crystal display unit) 5 and a plane light source unit adapted to illuminate the display unit from its backside. The plane or flat light source unit comprises one or a plurality of fluorescent discharge tube(s) (cold cathode tube(s)) 1, a reflector 2 disposed on the backside of the fluorescent discharged tube 1 for reflecting a light, a diffusing plate 3 interposed between the fluorescent discharged tube 1 and a display unit 5 so that the light can be diffused for uniformly illuminating the display unit 5, and a prism sheet 4 laminated on the display unit side of the diffusing plate 3. The plane display unit 5, in the case of a liquid crystal display unit, comprises a first polarizing film 6a, a first glass substrate 7a, a first electrode 8a disposed on the glass substrate, a first orientation (or alignment) layer 9a laminated on the electrode, a liquid crystal layer 10, a second orientation (or alignment) layer 9b, a second electrode 8b, a color filter 11, a second glass substrate 7b, and a second polarizing film 6b, each successively built up (laminated) in that order. In such a display apparatus, the display unit can directly be illuminated from the backside by the built-in fluorescent tube (cold cathode tube) 1. The backlight system using such a bar (or rod) light source (lamp) in a liquid crystal display apparatus has become important along with the increase in size of a liquid crystal television in recent years.

In the backlight type liquid crystal display apparatus using such a lamp (e.g., a bar light source), since the bar light source is disposed near the display unit, the display unit becomes heated. Therefore, the diffusing sheet (plate) also requires heat resistance. For example, an isotropic sheet comprising a matrix phase and a dispersed spherical phase dispersed therein, in which the matrix phase comprises a thermoplastic resin and the dispersed phase comprises a spherical cross-linked resin bead such as a cross-linked polystyrene bead, is known as the diffusing sheet. However, when the thermal stabilities of the matrix phase and/or the dispersed phase are low, the thermal contraction sometimes causes avoid in a boundary surface between the matrix phase and the dispersed phase or deformation of the film. Therefore, in some cases, the film cannot diffuse a transmitted light from the light source isotropically.

Moreover, in the backlight type liquid crystal display apparatus, since the luminance distribution in the axis direction of the tubular light source is different from that in a direction perpendicular to the axis direction, it is difficult to illuminate the display unit uniformly. The difficulty of the uniform illumination prevents the enlargement of the visual angle. Therefore, an anisotropic light-diffusing sheet having an optically anisotropic light-scattering characteristic as the diffusing sheet is used to uniformize the luminance with the anisotropic light-scattering characteristic.

Further, the following anisotropic light-diffusing sheet for diffusing a transmitted light anisotropically is also known as the diffusing sheet: the anisotropic light-diffusing sheet comprises a continuous phase comprising a thermoplastic resin and a dispersed phase dispersed therein to be oriented to a predetermined direction, and the dispersed phase has an aspect ratio of more than 1. For example, Japanese Patent Application Laid-Open No. 2706/1999 (JP-11-2706, Patent Document 1) discloses a diffusing film (or a diffusion film) which comprises a continuous phase comprising a resin and a dispersed phase having an aspect ratio of more than 1 dispersed therein. This document also discloses that the diffusing film may be formed from a plurality of resins selected from the group consisting of an olefinic resin, an acrylic resin, a styrenic resin, a polyester-series resin, a polyamide-series resin, and a polycarbonate-series resin. In a backlight type liquid crystal display apparatus using a lamp (e.g., a bar light source), such an anisotropic light-diffusing sheet is disposed so that the major-axis direction of the dispersed phase is oriented to the axis direction of the tubular light source, and the luminance of a transmitted light can be uniformized using the light-scattering characteristic of the diffusing sheet in spite of a use of a light source having a different luminance distribution between the major-axis direction and the minor axis direction.

Japanese Patent Application Laid-Open No. 90906/2003 (JP-2003-90906, Patent Document 2) discloses a light-diffusing film which comprises a light-diffusing layer comprising a continuous phase and a dispersed phase. In the light-diffusing film, the dispersed phase comprises a spherical particle having an average aspect ratio of 0.8 to 1.2 and an anisotropic particle having an average aspect ratio of not less than 1.5. Further, this document discloses that each of the continuous phase and the dispersed phase having an anisotropic shape comprises a transparent thermoplastic resin selected from the group consisting of a polyolefinic resin, a (meth)acrylic resin, a styrenic resin, a polyester-series resin, a polyamide-series resin, a polycarbonate-series resin, and a cellulose derivative, and the dispersed phase spherical particle comprises a cross-linked resin.

However, the light-diffusing film has an insufficient heat resistance. Therefore, a use of the light-diffusing sheet under a high-temperature environment (for example, in a direct illumination (direct type) apparatus comprising a light source for illuminating a display panel from a backside thereof without using a light guide plate) sometimes causes deformation of the film. In addition, when the matrix phase has an insufficient heat resistance, a distortion due to stretching (or drawing) causes a contraction of the film or a shape distortion of the dispersed phase. Therefore, the light-diffusing characteristic of the film is changed, and the luminance of a transmitted light cannot be uniformized.

Incidentally, a polycarbonate-series resin is known as a resin having an excellent heat resistance and a high transparency. However, since the polycarbonate-series resin has a low melting flowability, it is difficult to efficiently produce the light-diffusing film at an industrial scale by melt molding (such as melt extrusion molding). Moreover, since the affinity of the polycarbonate-series resin to the component of the dispersed phase is not very high, voids are easily made on a boundary surface between the matrix phase and the dispersed phase, and it is difficult to form the dispersed phase uniformly.

Further, as described above, the liquid crystal display apparatus provided with a fluorescent discharge tube, a diffusing plate, a prism sheet (if necessary, a protective film for a prism sheet), and others has a large number of components, and therefore the costs for raw materials and for assembling are high, and the fraction defective is increased because foreign materials are apt to enter between the components. Incidentally, although the foreign materials may be removed, the removal of the foreign materials further increases the costs for assembling. Accordingly, a low-cost liquid crystal display apparatus is also desirable.

For example, Japanese Patent Application Laid-Open No. 31774/2001 (JP-2001-31774A, Patent Document 3) discloses a transmissive light-scattering sheet having an islands-in-the-sea structure composed of resins different from each other in refractive index, wherein the average particle size of the island polymer is 0.5 to 10 μm, the ratio of the sea polymer relative to the island polymer is 70/30 to 40/60 (weight ratio), and the thickness of the sheet is 5 to 200 μm. The literature also discloses that the sheet diffuses the scattering light with orienting the scattered light within the range of a scattering angle of 5 to 50°.

However, when a picture image is displayed on a screen of a display apparatus provided with the film, a lamp image (an indistinct image due to the profile of a lamp (or light source), by which the presence of the lamp is recognized) inevitably appears on the screen, thereby the display uniformity is deteriorated. When the display uniformity is completely achieved, the lamp image becomes fainter while the luminance is remarkably deteriorated.

Moreover, Japanese Patent Application Laid-Open No. 50306/2003 (JP-2003-50306, Patent Document 4) discloses a light-diffusing film capable of scattering an incident light in a light-advancing (or light-traveling) direction. In the film, light-scattering characteristics Fx(θ) and Fy(θ) show a gradual decay pattern as a light-scattering angle θ becomes a wider angle, and a light-scattering characteristic F(θ) fulfills the following expressions representing the relationship between the light-scattering angle θ and a scattered light intensity F: 1.01≦Fy(θ)/Fx(θ)≦100 in the range of the scattering angle θ of 4 to 30° and 1.1≦Fy(θ)/Fx(θ)≦20 at the scattering angle θ of 18°, wherein Fx(θ) represents a light-scattering characteristic in an X-axis direction of the film and Fy(θ) represents a light-scattering characteristic in a Y-axis direction of the film.

However, since addition of a compatibilizing agent (or a compatibilizer) is required in order to impart an excellent light-scattering characteristic to the film and avoid generation of a void, it is difficult to prepare a sheet. Further, the resulting film has an insufficient light-scattering characteristic.

[Patent Document 1] JP-11-2706A (Claims)

[Patent Document 2] JP-2003-90906A (Claims)

[Patent Document 3] JP-2001-31774A (claim 1, Paragraph Number [0042])

[Patent Document 4] JP-2003-50306A (claim 1)

### DISCLOSURE OF THE INVENTION

### Problems to be Solved by the Invention

It is therefore an object of the present invention to provide a light-diffusing film (or a light diffusion film) of which the change in the light-diffusing characteristic can be inhibited even under a high temperature; a process for producing the film; and an apparatus (a plane light source device (or apparatus) or a display apparatus) provided (or equipped) with the film.

It is another object of the invention to provide a light-diffusing film which comprises a uniformly formed dispersed phase and diffuses a transmitted light isotropically or anisotropically in spite of a use of a polycarbonate-series resin having a low flowability and a low affinity; a process for producing the film; and an apparatus provided (or equipped) with the film.

It is still another object of the invention to provide a light-diffusing film which can maintain an optically anisotropic light-diffusing characteristic even when used under a high temperature in spite of having been stretched (or drawn); a process for producing the film; and an apparatus provided (or equipped) with the film.

It is a further object of the invention to provide an anisotropic light-diffusing film (or an anisotropic light diffusion film) which can make a display surface luminance uniform and prevent a lamp image from appearing even when used for a direct illumination (direct type) display apparatus comprising a light source for directly illuminating a display panel without using a light guide plate; a process for producing the film; and a liquid crystal display apparatus provided (or equipped) with the film.

It is a still further object of the invention to provide an anisotropic light-diffusing film which can make a display surface luminance uniform and prevent a lamp image from appearing even when used for a backlight type liquid crystal display apparatus; a process for producing the film; and a liquid crystal display apparatus provided (or equipped) with the film.

It is another object of the invention to provide an anisotropic light-diffusing film by which a diffusing plate to be disposed in front of a lamp (or a light source) of a backlight type liquid crystal display apparatus is dispensable for the apparatus; a process for producing the film; and a liquid crystal display apparatus provided (or equipped) with the film.

A further object of the invention is to provide an anisotropic light-diffusing film which can improve a luminance of a backlight type liquid crystal display apparatus without using a conventional diffusing plate having a thickness of several millimeters in spite of the anisotropic light-diffusing film of several tens micrometers thinness; a liquid crystal display apparatus provided (or equipped) with the film.

A still further object of the invention is to provide an anisotropic light-diffusing film which can be suited to a thin-type large-screen liquid crystal display apparatus and achieve an easy production of the apparatus; a process for producing the film; and a liquid crystal display apparatus provided (or equipped) with the film.

### Means to Solve the Problems

The inventors of the present invention made intensive studies to achieve the above objects and finally found that a combination use of a specific polycarbonate-series resin and a polypropylene-series resin uniformly forms a dispersed phase in spite of the polycarbonate-series resin having a poor flowability and a poor affinity, and inhibits the change in the light-diffusing characteristic even under a high temperature; and further that a use of an anisotropic light-diffusing film having a specific anisotropy and light-diffusing property (scattering property or haze) for a backlight type liquid crystal display apparatus makes a display surface luminance uniform and prevents a lamp image from appearing. The present invention was accomplished based on the above findings.

That is, the light-diffusing film (or light diffusion film) of the present invention comprises a light-diffusing layer (or light diffusion layer), and the light-diffusing layer comprises a continuous phase comprising a polycarbonate-series resin and a dispersed phase comprising a polypropylene-series resin. The light-diffusing layer of the light-diffusing film may be substantially free from a compatibilizing agent (or a compatibilizer). Moreover, the polycarbonate-series resin of the continuous phase may have a number average molecular weight of 15000 to 25000. The polycarbonate-series resin may have a melt flow rate of about 5 to 30 g/10 minutes in accordance with ISO (International Organization for Standardization) 1133 (300° C., 1.2 kg load). The polypropylene-series resin of the dispersed phase may comprise a metallocene-catalyzed (or metallocene type) resin (a metallocene-catalyzed polypropylene-series resin) or may comprise a polypropylene-series random copolymer. The polypropylene-series resin may have a melt flow rate of about 3 to 20 g/10 minutes in accordance with JIS (Japanese Industrial Standards) K7210 (230° C., 2.16 kg load). The light-diffusing layer may further contain at least one selected from the group consisting of an antioxidant and an ultraviolet ray absorbing agent.

The dispersed phase may have a spherical shape (or form) in order to diffuse a transmitted light isotropically. The dispersed phase may contain a particulate dispersed phase having an average aspect ratio of larger than 1 and a major-axis direction being oriented to a certain direction of the film, and a film having such a dispersed phase may anisotropically diffuse a transmitted light. In an anisotropic light-diffusing film, the average minor axis length of the particulate dispersed phase may be about 0.01 to 10 μm, and the average aspect ratio of the particulate dispersed phase may be about 3 to 20000. The anisotropic light-diffusing film may be an anisotropic light-diffusing film capable of scattering a transmitted light, and when F(θ) represents a light-scattering characteristic representing a relationship between a scattering angle θ and a scattered light intensity F, each of Fx(θ) and Fy(θ) may be attenuated (or decayed) with increasing the scattering angle θ, wherein Fx(θ) represents a light-scattering characteristic in the X-axis direction (MD) of the film and Fy(θ) represents a light-scattering characteristic in the Y-axis direction (CD) of the film. Moreover, the anisotropic light-diffusing film may have the light-scattering characteristics Fx(θ) and Fy(θ) which satisfy the following expression in the range of the scattering angle θ of 4 to 30°:

1.01≦Fy(θ)/Fx(θ)

and the following expression at the scattering angle θ of 18°:

20<Fy(θ)/Fx(θ)≦400.

The light-scattering characteristic may satisfy the following expression in the range of the scattering angle θ of 4 to 30°:

1.01≦Fy(θ)/Fx(θ)≦200

and the following expression at the scattering angle θ of 18°:

25≦Fy(θ)/Fx(θ)≦50.

Incidentally, the X-axis of the film means a stretching (or drawing) direction of the film (MD or machine direction) and the Y-axis of the film means a direction (CD or cross direction) perpendicular to the machine direction. Moreover, each of the characteristics, Fx(θ) and Fy(θ) represents a scattered light intensity of a transmitted light at a scattering angle θ in the case where an incident light comes vertically with respect to an anisotropic light-diffusing film, wherein y denotes a main scattering direction of the anisotropic light-diffusing film, and x denotes a direction perpendicular to the main scattering direction in a plane of the anisotropic light-diffusing film. Accordingly, Fy(θ) represents a scattered light intensity at the main scattering direction of the anisotropic light-diffusing film, and Fx(θ) represents a scattered light intensity at the direction perpendicular to the main scattering direction of the anisotropic light-diffusing film. Moreover, an X-axis direction of the anisotropic light-diffusing film is usually a major-axis direction of a particulate dispersed phase, and a Y-axis direction of the anisotropic light-diffusing film is usually a minor-axis direction of the particulate dispersed phase. Thus, Fx(θ) represents a scattered light intensity at the major axial direction of the particulate dispersed phase of the film, and Fy(θ) represents the scattered light intensity at the minor-axis direction of the particulate dispersed phase of the film.

Further, the ratio of the continuous phase relative to the dispersed phase [the continuous phase/the dispersed phase] may be about 99/1 to 50/50 (weight ratio).

Furthermore, the light-diffusing film may comprise the light-diffusing layer alone (or a monolayer (or single layer) sheet) or may comprise the light-diffusing layer and a transparent layer (such as a transparent resin layer) laminated on at least one side of the light-diffusing layer to form a laminated sheet (or a multilayer sheet). For example, the anisotropic light-diffusing film may comprise an anisotropic light-diffusing layer which diffuses a transmitted light anisotropically, and a transparent layer laminated on at least one side of the light-diffusing layer. The transparent layer may be a resin layer containing at least one selected from the group consisting of an ultraviolet ray absorbing agent and a light stabilizer.

The thickness of the light-diffusing film is not particularly limited to a specific one. In spite of having a small thickness, the light-diffusing film has an excellent light-diffusing property. Therefore, the thickness of the light-diffusing layer may be about 3 to 300 μm, and the total light transmittance of the light-diffusing film may be not less than 60%.

The present invention also includes a plane light source device (or apparatus) provided (or equipped) with the light-diffusing film and a display apparatus (or device) (e.g., a liquid crystal display apparatus) provided with the light-diffusing film. In particular, the present invention also includes a plane (or flat) light source device in which the anisotropic light-diffusing film is disposed on a light-emitting side of a plane light source unit.

Further, the present invention includes a transmissive (or transmittable) display apparatus (e.g. a transmissive liquid crystal display apparatus) provided (or equipped) with a display unit and the above-mentioned plane light source device for illuminating the display unit. In particular, the display apparatus may use a direct illumination system, in which a display unit is illuminated from a backside thereof with light sources disposed in parallel with each other. In the display apparatus, the light-diffusing film may be an anisotropic light-diffusing film. Further, assuming that a horizontal direction of a display surface of the display unit is Y-axis, the light-diffusing film may be disposed in such a manner that the Y-axis of the light-diffusing film is parallel with the Y-axis of the display surface.

In the display apparatus, the anisotropic light-diffusing film may be used as a diffusing film for uniformizing a luminance, and the anisotropic light-diffusing film can uniformize an emitting surface luminance of the display apparatus. The anisotropic light-diffusing film diffuses a light to the horizontal direction of the display surface in a moderate (or reasonable) intensity to inhibit a change in the display surface luminance due to a bar light source (lamp), and eliminates a lamp image caused by an increase in lightness of the area corresponding to the bar light source (lamp). Further, the anisotropic light-diffusing film diffuses a light to the vertical direction of the display surface in a moderate (or reasonable) intensity to avoid a nonuniform luminance in the vertical direction. Incidentally, although an anisotropic light-diffusing film having an excessively large anisotropy highly prevents a lamp image from appearing, the film causes a significant deterioration of the luminance. On the other hand, although an anisotropic light-diffusing film having an excessively small anisotropy improves the luminance, the film insufficiently prevents a lamp image from appearing.

Further, one sheet of an anisotropic light-diffusing film having an appropriately adjusted anisotropy can be used as a substitute for a combination of a conventional diffusing sheet and prism sheet (and if necessary, a protective sheet therefor). Therefore, the anisotropic light-diffusing film can improve the luminance of a display and prevent a lamp image from appearing, and the raw material costs of the plane light source device, assembly costs and process costs, and fraction defective (e.g., invasion of foreign substances) can be reduced, resulting in a serious cost reduction of the plane light source device.

Incidentally, throughout this specification, the term “film” is used without regard to thickness, thus means a sheet as well.

### EFFECTS OF THE INVENTION

According to the present invention, since a matrix phase (the continuous phase) comprises a polycarbonate-series resin and the dispersed phase comprises a polypropylene-series resin, the light-diffusing film has a high heat resistance and inhibits a change in a light-diffusing characteristic over a long period of time even when used under a high temperature. Moreover, the light-diffusing film comprises a uniformly formed dispersed phase and diffuses a transmitted light isotropically or anisotropically in spite of a use of the polycarbonate-series resin having a low flowability and a low affinity. Further, the light-diffusing film maintains an optically anisotropic light-diffusing characteristic even when used under a high temperature in spite of having been stretched (or drawn).

Furthermore, according to the present invention, a use of an anisotropic light-diffusing film having a specific anisotropy and a specific light-diffusing property for a backlight type liquid crystal display apparatus makes a display surface luminance uniform and prevents a lamp image from appearing. In more detail, since a light from a bar light source (a fluorescent tube) is efficiently and reasonably scattered to a direction perpendicular to the length direction of the bar light source due to a reasonably high anisotropic light scattering property of the film, the film keeps the reduction in the luminance to a minimum and eliminates the lamp image, by which a tubular light source itself is recognized. In particular, since the film has a high heat resistance, a direct illumination display apparatus, in which a diffusing sheet is directly illuminated by a tubular light source without using a light guide plate, provided with the film displays a screen image at a uniform luminance over a long period of time. Therefore, the film of the present invention is useful for a large-screen (or large-sized) liquid crystal display apparatus. Moreover, by the film of the present invention, a diffusing plate to be disposed on a front of a lamp of a backlight type liquid crystal display apparatus is dispensable. Further, the film can improve the luminance of the backlight type liquid crystal display apparatus in spite of the film of several tens micrometers (about 0.2 mm) thinness. Furthermore, the present invention is suited to a thin-type large-screen liquid crystal display apparatus and achieves simple or easy production of the apparatus. That is, since the anisotropic light-diffusing film of the present invention has a small thickness, the large-screen liquid crystal display apparatus is easily produced using small amounts of raw materials.

### BRIEF DESCRIPTION OF DRAWINGS

FIG. 1 represents a schematic sectional view illustrating a plane light source device and a transmissive liquid crystal display apparatus.

FIG. 2 represents a schematic sectional view illustrating an example of an anisotropic light-diffusing film.

FIG. 3 represents a schematic sectional view illustrating another example of an anisotropic light-diffusing film.

FIG. 4 represents a schematic diagram for explaining an anisotropic scattering of an anisotropic light-diffusing film.

FIG. 5 represents a schematic view for explaining a measuring method of a light-scattering characteristic.

### DETAILED DESCRIPTION OF THE INVENTION

### Light-Diffusing Film

The light-diffusing film of the present invention comprises a light-diffusing layer comprising a continuous phase (a matrix phase) and a dispersed phase, and the continuous phase comprises a polycarbonate-series resin and the dispersed phase comprises a polypropylene-series resin. The dispersed phase may be in a spherical shape (or form) or an anisotropic shape (or form).

The polycarbonate-series resin may include an aromatic polycarbonate comprising a bisphenol compound as a base component, and others. The bisphenol compound may include, for example, a bisphenol compound such as dihydroxybiphenyl; a bis(hydroxyaryl)alkane compound such as bisphenol A, bisphenol F, or bisphenol AD; a bis(hydroxyaryl)cycloalkane compound such as bis(hydroxyphenyl)cyclohexane; a di(hydroxyphenyl)ether compound such as 4,4′-di(hydroxyphenyl)ether; a di(hydroxyphenyl) ketone compound such as 4,4′-di(hydroxyphenyl) ketone; a di(hydroxyphenyl) compound such as bisphenol S; a bis(hydroxyphenyl)sulfone compound; and a bisphenolfluorene compound such as 9,9-bis(4-hydroxyphenyl)fluorene. These bisphenol compounds may be a C₂₋₄alkylene oxide adduct. These bisphenol compounds may be used alone or in combination.

The polycarbonate-series resin may be a polyester carbonate-series resin obtainable by copolymerizing a dicarboxylic acid component (e.g., an aliphatic, alicyclic or aromatic dicarboxylic acid or an acid halide thereof). These polycarbonate-series resins may be used alone or in combination. The preferred polycarbonate-series resin includes a resin comprising a bis(hydroxyphenyl) C₁₋₆alkane compound as a base component, for example, a bisphenol A-based polycarbonate-series resin.

The number average molecular weight of the polycarbonate-series resin may be selected from the range of about 10000 to 50000 (for example, about 15000 to 30000), for example, is about 12500 to 30000 (e.g., about 15000 to 25000), and preferably about 17000 to 25000 (e.g., about 18000 to 22000). A polycarbonate-series resin having an excessively small molecular weight decreases the strength of the film. A polycarbonate-series resin having an excessively large molecular weight tends to decrease melt flowability and uniform dispersibility of the dispersed phase. A combination use of the polycarbonate-series resin and a specific polypropylene-series resin can form a dispersed phase having a high aspect ratio with avoiding generation of a void without using a compatibilizing agent.

The melt flow rate (MFR) of the polycarbonate-series resin may be determined in accordance with ISO 1133 (300° C., 1.2 kg load (11.8 N)) and may be selected, for example, from the range of about 3 to 30 g/10 minutes (e.g., about 4 to 20 g/10 minutes), and is usually about 5 to 30 g/10 minutes (e.g., about 5 to 15 g/10 minutes), preferably about 6 to 25 g/10 minutes (e.g., about 7 to 20 g/10 minutes), and more preferably about 8 to 15 g/10 minutes (e.g., about 9 to 12 g/10 minutes).

The melting point or glass transition temperature of the polycarbonate-series resin is, for example, about 130 to 280° C., preferably about 140 to 270° C., and more preferably about 150 to 260° C.

Such a polycarbonate-series resin is usually classified as “Medium-viscosity product”, “Low-viscosity product”, or “High-viscosity product” in terms of grade in a product catalog.

The polypropylene-series resin for forming the dispersed phase may include a polypropylene (homopolymer) and a copolymer of propylene and a copolymerizable monomer. The copolymerizable monomer may include an olefin (e.g., ethylene, and an α-C₄₋₁₀olefin such as butene, pentene, heptene, or hexene), a (meth)acrylic monomer (e.g., (meth)acrylic acid, a C₁₋₁₀alkyl ester of (meth) acrylic acid, a hydroxyalkyl ester of (meth)acrylic acid, and a glycidyl ester of (meth)acrylic acid), a vinyl ester of a fatty acid (e.g., vinyl acetate), a diene compound, and others. These copolymerizable monomers may be used alone or in combination. Among these copolymerizable monomers, an α-olefin (e.g., ethylene, butene) is often used.

The propylene content of the propylene-series copolymer is usually not less than 80% by mol (80 to 100% by mol), preferably not less than 85% by mol, and more preferably not less than 90% by mol. The propylene-series copolymer may be a block copolymer, and is usually a random copolymer.

The preferred polypropylene-series resin includes a polypropylene homopolymer, a propylene-ethylene copolymer, a propylene-butene copolymer, a propylene-ethylene-butene copolymer, and others. The polypropylene-series polymer to be used is often a polypropylene homopolymer, and/or a propylene-ethylene copolymer.

The polypropylene-series resin may be a polymer obtainable by using a Ziegler catalyst or the like (or a Ziegler-catalyzed polymer), and is preferably a resin obtainable by polymerization using a metallocene catalyst (or a metallocene-catalyzed resin). The metallocene-catalyzed resin is characterized by having a narrow molecular weight distribution and containing small amounts of a low-molecular weight component and a low-crystallization component. Due to the characteristics, the polypropylene-series resin phase (dispersed phase) can uniformly be dispersed in the matrix phase comprising the polycarbonate-series resin without using a compatibilizing agent.

In the molecular weight distribution of the polypropylene-series resin according to a gel-permeation chromatography (GPC), for example, the weight average molecular weight Mw relative to the number average molecular weight Mn (Mw/Mn) may be about 1 to 2.5 (e.g., about 1.2 to 2.3), preferably about 1.3 to 2 (e.g., about 1.5 to 1.8), and usually about 1.3 to 2.5 (e.g., about 1.5 to 2.0). The weight average molecular weight Mw of the polypropylene-series resin may be, for example, about 1×10⁴ to 100×10⁴, preferably about 2×10⁴ to 75×10⁴ (e.g., about 3×10⁴ to 50×10⁴), and more preferably about 3×10⁴ to 30×10⁴. Moreover, according to the GPC, the proportion of a low molecular weight component having a molecular weight of not more than 10000 is, for example, not more than 1% by volume, preferably not more than 0.5% by volume, and more preferably not more than 0.3% by volume in the resin. Incidentally, the molecular weight and the molecular weight distribution according to the GPC may be measured at a temperature of 135° C. using an apparatus (Waters Alliance GPCV-2000, a column: PL20 μm MIXED-A, a detector: RI, and a solvent: o-dichlorobenzene). The above-mentioned values of the molecular weight and the molecular weight distribution are values in terms of a polypropylene by an all-purpose calibration curve method using a monodisperse polystyrene as a reference material

The MFR (melt flow rate) of the polypropylene-series resin is, for example, about 3 to 20 g/10 minutes, preferably about 4 to 15 g/10 minutes, and more preferably about 5 to 10 g/10 minutes in accordance with JIS K7210 (230° C., 2.16 kg load (21.2 N)).

The polypropylene-series resin may be crystalline. The degree of crystallinity of the crystalline polypropylene-series resin may be, for example, about 10 to 80%, preferably about 20 to 70%, and more preferably about 30 to 60%. The melting point of the polypropylene-series resin (melting peak temperature measured by a differential scanning calorimeter (DSC)) is, for example, about 100 to 140° C., preferably about 110 to 135° C., and more preferably about 115 to 130° C. (e.g., about 120 to 130° C.). The difference in melting point or glass transition temperature between the polypropylene-series resin and the polycarbonate-series resin constituting the continuous phase may be, for example, about 10 to 200° C., preferably about 30 to 150° C., and more preferably about 50 to 120° C.

Further, the ratio of the MFR of the polycarbonate-series resin relative to the MFR of the polypropylene-series resin (the former/the latter) may be about 0.8/1 to 2.5/1 (e.g., about 0.9/1 to 2.3/1), preferably about 1/1 to 2/1, and more preferably about 1.2/1 to 1.7/1.

In order to impart the light-diffusing property to the film, the continuous phase and the dispersed phase respectively comprise a first component and a second component different in refractive indexes. The difference in refractive index between the polycarbonate-series resin and the polypropylene-series resin is, for example, not less than 0.001 (e.g., about 0.001 to 0.3), preferably about 0.01 to 0.3, and more preferably about 0.01 to 0.1.

A copolymer (e.g., a propylene-ethylene random copolymer) or a metallocene-catalyzed resin, particularly a metallocene-catalyzed copolymer, is preferred as the polypropylene-series resin.

A combination use of such a polypropylene-series resin and the polycarbonate-series resin can form a dispersed phase (for example, a dispersed phase having a predetermined aspect ratio) without generating a void in spite of not substantially containing a compatibilizing agent, as described above.

In the light-diffusing layer, the ratio of the continuous phase relative to the dispersed phase (the former/the latter (weight ratio)) may be, for example, selected from the range of about 99/1 to 30/70 (e.g., about 95/5 to 40/60) depending on the species or melt viscosity of the resin, the light-diffusing property, and others, and for example, may be about 99/1 to 50/50 (e.g., about 95/5 to 50/50), preferably about 99/1 to 75/25 (e.g., about 93/7 to 70/30), more preferably about 95/5 to 60/40, and particularly about 90/10 to 75/25.

A combination use of the polycarbonate-series resin and the polypropylene-series resin provides a film which not only has a practical heat stability but also anisotropically diffuses a transmitted light due to easy deformation of the dispersed phase at an orientation treatment temperature (e.g., a uniaxial stretching temperature). Further, the aspect ratio of the dispersed phase particle can be controlled by a draw ratio in an extrusion molding process or by an orientation treatment such as a uniaxial stretching, thereby a dispersed phase having a large aspect ratio can be formed easily. Furthermore, since the continuous phase comprises the polycarbonate-series resin, the film can also have improved heat resistance and blocking resistance.

The light-diffusing layer may contain a compatibilizing agent if necessary. With the compatibilizing agent, the miscibility and mutual affinity of the continuous and dispersed phases can be improved, the formation of defects (voids and other defects) on orientation of the film can be prevented, and the loss of transparency of the film can be prevented. Furthermore, the adhesion between the continuous phase and the dispersed phase can be improved. Therefore, in spite of uniaxially stretching the film, the adhesion of the dispersed phase on the stretching equipment can be decreased.

The compatibilizing agent may include, for example, a bisoxazoline compound, a resin obtainable by modifying an olefinic resin with a modifying group (e.g., a carboxyl group, an acid anhydride group, an epoxy group, and an oxazolinyl group) (a modified olefinic resin), a diene- or rubber-containing polymer [for example, a homopolymer of a diene-series monomer such as butadiene or isoprene, or a diene-series copolymer obtainable by copolymerization of a diene-series monomer and a copolymerizable monomer (e.g., an aromatic vinyl monomer such as styrene) (e.g., a random copolymer); and a diene-series block copolymer or a hydrogenated product thereof, e.g., a diene-series graft copolymer such as an acrylonitrile-butadiene-styrene copolymer (ABS resin); a styrene-butadiene (SB) block copolymer, a hydrogenated styrene-butadiene (SB) block copolymer, a hydrogenated styrene-butadiene-styrene block copolymer (SEBS), and a hydrogenated (styrene-ethylene/butylene-styrene) block copolymer], and a polymer obtainable by modifying a diene- or rubber-containing polymer (e.g., the above-mentioned block copolymer) with the above-mentioned modifying group (e.g., epoxy group) (a modified diene- or rubber-containing polymer). These compatibilizing agents may be used alone or in combination.

The diene-series monomer may include a conjugated diene such as a C₄₋₂₀conjugated diene which may have a substituent, for example, butadiene, isoprene, 1,3-pentadiene, 2,3-dimethyl-1,3-butadiene, piperylene (1,3-pentadiene), 3-butyl-1,3-octadiene, and phenyl-1,3-butadiene. The conjugated dienes may be used alone or in combination. Among these conjugated dienes, butadiene or isoprene is preferred. The above-mentioned aromatic vinyl monomer may include, for example, styrene, α-methylstyrene, vinyltoluene (e.g., p-methylstyrene), p-t-butylstyrene, and a divinylbenzene compound. Among these aromatic vinyl monomers, styrene is preferred. These monomers may be used alone or in combination.

Incidentally, the modification is conducted by copolymerizing a monomer with a monomer corresponding to the modifying group [for example, a carboxyl group-containing monomer (e.g., (meth)acrylic acid) for a modification with a carboxyl group; maleic anhydride for a modification with an acid anhydride group; a (meth)acrylic monomer for a modification with an ester group; a maleimide-series monomer for a modification with a maleimide group; and an epoxy group-containing monomer (e.g., glycidyl (meth)acrylate) for an epoxy modification]. Moreover, the epoxy modification may be conducted by epoxidation of an unsaturated double bond.

The compatibilizing agent to be employed usually includes a polymer (a random, block, or graft copolymer) having the same or common component as or with a resin constituting a polymer blend system, a polymer (a random, block, or graft copolymer) having an affinity for a resin constituting a polymer blend system, and others.

The preferred compatibilizing agent includes an unmodified or modified diene-series copolymer, particularly a modified block copolymer (for example, an epoxidized diene-series block copolymer or epoxy-modified diene-series block copolymer, such as an epoxidized styrene-butadiene-styrene (SBS) block copolymer). The epoxidized diene-series block copolymer has not only a high transparency but also a relatively high softening temperature (about 70° C.). Therefore, such a copolymer makes the polycarbonate-series resin and the polypropylene-series resin compatible with each other, and the dispersed phase can uniformly be dispersed.

The block copolymer may comprise, for example, a conjugated diene block or a partially hydrogenated block thereof and an aromatic vinyl block. In the epoxidized diene-series block copolymer, part or all of double bonds in the conjugated diene block are epoxidized. The ratio (weight ratio) of the aromatic vinyl block relative to the conjugated diene block (or a hydrogenated block thereof) [the former/the latter] is, for example, about 5/95 to 80/20 (e.g., about 25/75 to 80/20), more preferably about 10/90 to 70/30 (e.g., about 30/70 to 70/30), and usually about 50/50 to 80/20.

The number average molecular weight of the block copolymer may be selected from the range of, for example, about 5,000 to 1,000,000, preferably about 7,000 to 900,000, and more preferably about 10,000 to 800,000. The molecular weight distribution [the ratio of the weight average molecular weight (Mw) relative to the number average molecular weight (Mn) (Mw/Mn)] is, for example, not more than 10 (about 1 to 10) and preferably about 1 to 5.

The molecular structure of the block copolymer may be linear (straight), branched, radial or any combination thereof. The block structure of the block copolymer may include, for example, a monoblock structure, a multiblock structure such as a tereblock structure, a trichain-radial tereblock structure, and tetrachain-radial tereblock structure. Such block structures may for example be written as X—Y, X—Y—X, Y—X—Y, Y—X—Y—X, X—Y—X—Y, X—Y—X—Y—X, Y—X—Y—X—Y, (X—Y—)₄Si, and (Y—X—)₄Si, where X represents an aromatic diene block and Y represents a conjugated vinyl block.

The proportion of epoxy groups in the epoxidized diene-series block copolymer is not particularly limited to a specific one. The proportion may be, in terms of oxygen concentration of oxirane, for example, about 0.1 to 8% by weight, preferably about 0.5 to 6% by weight, and more preferably about 1 to 5% by weight. The epoxy equivalent (JIS K7236) of the epoxidized block copolymer may be, for example, about 300 to 1000, preferably about 500 to 900, and more preferably about 600 to 800.

Incidentally, the refractive index of the compatibilizing agent (e.g. epoxidized block copolymer) may be approximately the same as that of the polypropylene-series resin (for example, the difference in refractive index between the compatibilizing agent and the polypropylene-series resin may be about 0 to 0.01, and preferably about 0 to 0.005).

The epoxidized block copolymer may be produced by epoxidizing the diene-series block copolymer (or partially hydrogenated block copolymer) using a conventional epoxidizing method, for example, by epoxidizing the block copolymer with an epoxidizing agent (such as a peracid or a hydroperoxide) in an inactive solvent.

The amount of the compatibilizing agent to be used may be selected from the range of, for example, about 0.1 to 20% by weight, preferably about 0.5 to 15% by weight, and more preferably about 1 to 10% by weight, relative to the total amount of the polycarbonate-series resin and the polypropylene-series resin. Incidentally, as described above, according to the present invention, the dispersed phase can uniformly be dispersed by the combination use of the above-mentioned specified polycarbonate-series resin and the specified polypropylene-series resin in spite of being free from a compatibilizing agent. Moreover, such a combination allows forming of an anisotropic light-diffusing film having a high transmittance without generation of avoid in spite of an orientation treatment such as a uniaxial stretching.

In the preferred light-diffusing film, the proportions of the continuous phase, the dispersed phase, and the compatibilizing agent are, for example, as follows:

(1) the weight ratio of the continuous phase relative to the dispersed phase (the continuous phase/the dispersed phase) is about 99/1 to 50/50, preferably about 97/3 to 60/40, more preferably about 95/5 to 70/30, and particularly about 90/10 to 80/20; and

(2) the weight ratio of the dispersed phase relative to the compatibilizing agent (the dispersed phase/the compatibilizing agent) is about 100/0 to 50/50, preferably about 99/1 to 70/30, and more preferably about 98/2 to 80/20.

Incidentally, according to the present invention, the dispersed phase can uniformly be dispersed by combining the polycarbonate-series resin and the polypropylene-series resin without containing the compatibilizing agent.

A use of each component in such a ratio allows uniformly dispersing of the dispersed phase in spite of direct melt-kneading of pellets of each component without compounding of each component beforehand and can inhibit the generation of a void due to an orientation treatment such as a uniaxial stretching. Therefore, an anisotropic light-diffusing film having a high transmittance can be obtained.

More specifically, a resin composition, for example, containing the polycarbonate-series resin as the continuous phase and the polypropylene-series resin as the dispersed phase in the above-mentioned ratio can easily be compounded, a film can be formed by simply feeding the raw materials and melting the raw materials while compounding, and an anisotropic light-diffusing film in which the generation (or formation) of a void is prevented in spite of a uniaxial stretching can be obtained.

Incidentally, the component to be used for the dispersed phase may include a polymer, for example, a polyethylene-series resin, a styrenic resin, an aromatic polyester-series resin [for example, a poly(alkylene arylate) homopolyester (such as a poly(alkylene terephthalate) or a poly(alkylene naphthalate), a copolyester having an alkylene arylate unit content of not less than 80% by mol, and a liquid crystalline aromatic polyester), and a polyamide-series resin (for example, an aliphatic polyamide such as a polyamide 46, a polyamide 6, or a polyamide 66), and an inorganic particle such as a silica, as long as the component does not have an adverse affect on the light-diffusing characteristic.

Further, the light-diffusing layer may contain a conventional additive, for example, a stabilizer (e.g., an antioxidant, an ultraviolet ray absorbing agent, a heat stabilizer, and a light stabilizer), a plasticizer, an antistatic agent, and a flame retardant.

Examples of the antioxidant may include a phenol-series antioxidant, a hydroquinone-series antioxidant, a quinoline-series antioxidant, and a sulfur-containing antioxidant. The phenol-series antioxidant preferably includes a hindered phenol compound, for example, an alkylphenol-series antioxidant such as 2,6-di-t-butyl-p-cresol, 2,2′-methylenebis(4-methyl-6-t-butylphenol), or 2,2′-thiobis(4-methyl-6-t-butylphenol); a C₁₀₋₃₅alkyl[3-(3,5-di-t-butyl-4-hydroxyphenyl) propionate] such as n-octadecyl[3-(3,5-di-t-butyl-4-hydroxyphenyl) propionate]; a C₂₋₁₀alkanediol-bis[3-(3,5-di-t-butyl-4-hydroxyphenyl) propionate] such as 1,6-hexanediol-bis[3-(3,5-di-t-butyl-4-hydroxyphenyl) propionate]; an oxy C₂₋₄alkylenediol-bis[3-(3,5-di-t-butyl-4-hydroxyphenyl) propionate] such as triethylene glycol-bis[3-(3-t-butyl-5-methyl-4-hydroxyphenyl) propionate]; a C₃₋₈alkylenetriol-tris[3-(3,5-di-t-butyl-4-hydroxyphenyl)propionate] such as glycerin-tris[3-(3,5-di-t-butyl-4-hydroxyphenyl) propionate]; a C₄₋₈alkylenetetraoltetrakis[3-(3,5-di-t-butyl-4-hydroxyphenyl) propionate] such as pentaerythritoltetrakis[3-(3,5-di-t-butyl-4-hydroxyphenyl)propionate]; and an N,N′—C₂₋₁₀alkylenebis(3,5-di-t-butyl-4-hydroxyhydrocinnamamide such as N,N′-hexamethylenebis(3,5-di-t-butyl-4-hydroxyhydrocinnamamide)).

The amine-series antioxidant may include a hindered amine compound, for example, 1,2-bis(2,2,6,6-tetramethyl-4-piperidyloxy)ethane, phenylnaphthylamine, N,N′-diphenyl-1,4-phenylenediamine, and N-phenyl-N′-cyclohexyl-1,4-phenylenediamine.

The hydroquinone-series antioxidant may include, for example, 2,5-di-t-butylhydroquinone. The quinoline-series antioxidant may include, for example, 6-ethoxy-2,2,4-trimethyl-1,2-dihydroquinoline. Moreover, the sulfur-containing antioxidant may include, for example, dilaurylthiodipropionate and distearylthiodipropionate.

The ultraviolet ray absorbing agent may include, for example, a salicylic acid ester-series ultraviolet ray absorbing agent such as phenyl salicylate or 2,4-di-t-butylphenyl-3,5-di-t-butyl-4-hydroxybenzoate; a benzotriazole-series ultraviolet ray absorbing agent such as 2-(2-hydroxy-5-methylphenyl)benzotriazole, 2-[2-hydroxy-3-(3,4,5,6-tetrahydrophthalimide-methyl)-5-methylphenyl]benzotriazole, 2-(3-t-butyl-2-hydroxy-5-methylphenyl)-5-chlorobenzotriazole, 2-(2-hydroxy-5-t-butylphenyl)benzotriazole, 2-(2-hydroxy-3,5-di-t-butylphenyl)benzotriazole, 2-(2-hydroxy-3,5-bis(α,α-dimethylbenzyl)phenyl)benzotriazole, octyl-3-[3-t-butyl-4-hydroxy(5-chloro-2H-benzotriazol-2-yl)phenyl]propionate, 2-(2H-benzotriazol-2-yl)-4,6-bis(1-methyl-1-phenylethyl)phenol, or 2-(2H-benzotriazole-2-yl)-6-(1-methyl-1-phenylethyl)-4-(1,1,3,3-tetramethylbutyl)phenol; a benzophenone-series ultraviolet ray absorbing agent such as 2-hydroxybenzophenone, 2-hydroxy-4-methoxybenzophenone, 2-hydroxy-4-octyloxybenzophenone, or 2,2′-dihydroxy-4-methoxybenzophenone; and a hydroxyphenyltriazine-series ultraviolet ray absorbing agent such as a reaction product of 2-(4,6-bis(2,4-dimethylphenyl)-1,3,5-triazin-2-yl)-5-hydroxyphenyl and oxirane, a reaction product of 2-(2,4-dihydroxyphenyl)-4,6-bis(2,4-dimethylphenyl)-1,3,5-triazine) and 2-ethylhexylglycidic acid ester, or 2,4-bis[2-hydroxy-4-butoxyphenyl]-6-(2,4-dibutoxyphenyl)-1,3,5-triazine.

The light stabilizer (HALE) may include a compound having a 2,2,6,6-tetramethylpiperidine skeleton or a 1,2,2,6,6-pentamethyl-4-piperidine skeleton, for example, N,N′,N″,N′″-tetrakis(4,6-bis(butyl(N-methyl-2,2,6,6-tetramethylpiperidin-4-yl)amino)triazin-2-yl)-4,7-diazadecane-1,10-diamine, decanedioic acid bis(2,2,6,6-tetramethyl-1-octyloxy-4-piperidinyloxy) ester, bis(1,2,2,6,6-pentamethyl-4-piperidinyl) [[3,5-bis(1,1-dimethylethyl)-4-hydroxyphenyl]methyl]butyl malonate, bis(1,2,2,6,6-pentamethyl-4-piperidinyl) sebacate, a C₄₋₂₀alkane-dicarboxylic acid ester corresponding to each of these dicarboxylic acid esters (e.g., a malonate and an), an acid ester corresponding to each of these dicarboxylic acid esters (e.g., a terephthalate), and others.

The heat stabilizer may include, for example, a phosphorus-containing stabilizer (or a phosphoric acid ester) such as a phosphite-series stabilizer (e.g., a tris(branched alkylphenyl) phosphite such as tris(2,4-di-t-butylphenyl) phosphite, and a bis(alkylaryl)pentaerythritol diphosphite), a sulfur-containing heat stabilizer, and a hydroxylamine-series heat stabilizer.

These stabilizers (for example, a light stabilizer) may be a low molecular weight one or a high molecular weight one. Moreover, these stabilizers may be used alone or in combination of two or more components (for example, a combination of an antioxidant and a ultraviolet ray absorbing agent; a combination of an ultraviolet ray absorbing agent and a light stabilizer; and a combination of an antioxidant, an ultraviolet ray absorbing agent, and a light stabilizer). The amount to be used of each stabilizer relative to 100 parts by weight of the resin component constituting the light-diffusing layer is often about 0.01 to 2.5 parts by weight, preferably about 0.03 to 2 parts by weight (e.g., about 0.05 to 1.5 parts by weight) and more preferably about 0.07 to 1 parts by weight (e.g., about 0.1 to 0.7 parts by weight), and is usually about 0.07 to 0.5 parts by weight (e.g., about 0.1 to 0.3 parts by weight). More specifically, the antioxidant may be about 0.05 to 1 parts by weight (e.g., about 0.08 to 0.3 parts by weight) relative to 100 parts by weight of the resin component; the ultraviolet ray absorbing agent may be about 0.1 to 2 parts by weight (e.g., about 0.2 to 0.7 parts by weight) relative to 100 parts by weight of the resin component; the light stabilizer may be about 0.03 to 0.5 parts by weight (e.g., about 0.05 to 0.25 parts by weight) relative to 100 parts by weight of the resin component. Incidentally, the total amount of the above-mentioned stabilizers may be about 0.05 to 3 parts by weight (e.g., about 0.1 to 2 parts by weight) and preferably about 0.1 to 1 parts by weight relative to 100 parts by weight of the resin component. Further, when a plural species of stabilizers are used in combination, the ratio of a first stabilizer (e.g., an antioxidant) relative to a second stabilizer (e.g., an ultraviolet ray absorbing agent) [the former/the latter (weight ratio)] may be selected from the range of about 95/5 to 10/90 (e.g., about 90/10 to 30/70).

Incidentally, when an alloy system containing the polycarbonate-series resin in combination with the polypropylene-series resin is subjected to melt-extrusion molding or compounding, part of the extruded matter gradually deposits (or accumulates) in a gum state (or in an eye-mucus-like state) on a die lip (particularly, a wall adjacent to an opening of a die lip). This deposit grows and comes in contact with a molten sheet extruded from the die lip to form a nonuniform (or uneven) sheet. Therefore, uniform (or even) sheet and film cannot be produced continuously. In such a case, addition of the above-mentioned stabilizer(s) (for example, the antioxidant and/or the ultraviolet ray absorbing agent), particularly at least one selected from the group consisting of the antioxidant and the ultraviolet ray absorbing agent (e.g., the antioxidant alone, the ultraviolet ray absorbing agent alone, and both the antioxidant and the ultraviolet ray absorbing agent) to the alloy system can remarkably prevent the generation and growth of the deposit and provide the continuous production of uniform (or even) sheet and film. Incidentally, the antioxidant and/or the ultraviolet ray absorbing agent, particularly at least the antioxidant, may be contained in the light-diffusing layer, which comes in contact with the die lip; or in a light-diffusing film having a laminated (or multilayer) structure, may be contained in a transparent resin layer which is laminated on the light-diffusing layer, or may be contained in both the light-diffusing layer and transparent resin layer. The light-diffusing layer usually contains at least one selected from the group consisting of the antioxidant and the ultraviolet ray absorbing agent.

The shape (or form) of the dispersed phase in the light-diffusing layer may be a spherical shape having a ratio (average aspect ratio, L/W) of an average major axis length L relative to an average minor axis length W of about 1 to 1.25 or may be in the shape of a rugby ball (an oval sphere such as an ellipsoid of gyration), a flat body, a rectangular solid, a fibrous form, or a filiform body. The aspect ratio of the dispersed phase is usually larger than 1 (e.g., about 1.01 to 20000), for example, about 3 to 20000 (e.g., about 5 to 15000), preferably about 10 to 12000 (e.g., about 50 to 10000), and more preferably about 100 to 9000 (e.g., about 200 to 8000). In particular, for increase in the anisotropy, the aspect ratio of the dispersed phase may be about 10 to 15000 (e.g., about 100 to 10000) and more preferably about 1000 to 9000 (e.g., about 3000 to 8000). The larger the aspect ratio of the dispersed phase particle is, the higher the anisotropic light-scattering properties the layer has. In the light-diffusing layer which diffuses a transmitted light anisotropically, the particulate dispersed phase is formed so that the major-axis direction of the dispersed phase is oriented to a predetermined direction of the film, that is, X-axis direction (drawing direction or machine direction).

Incidentally, the average major axis length L of the dispersed phase is, for example, about 0.1 to 2000 μm (e.g., about 0.5 to 1500 μm), preferably about 1 to 1200 μm (e.g., about 1.5 to 1000 μm), particularly about 2 to 900 μm (e.g., about 5 to 800 μm), and usually about 100 to 1000 μm (e.g., about 300 to 800 μm). Moreover, the average minor axis length W of the dispersed phase is, for example, about 0.01 to 10 μm (e.g., about 0.02 to 5 μm), preferably about 0.03 to 5 μm (e.g., about 0.05 to 3 μm), and more preferably about 0.07 to 1 μm (e.g., about 0.1 to 0.5 μm).

The orientation coefficient of the dispersed phase particle as an index of the degree of orientation may be, for example, not less than 0.34 (about 0.34 to 1), preferably about 0.4 to 1 (e.g., about 0.5 to 1), and more preferably about 0.7 to 1. The higher the orientation coefficient of the dispersed phase is, more anisotropically the light is scattered. Incidentally, the orientation coefficient can be calculated based on the following formula:

Orientation coefficient=(3<cos²θ>−1)/2

wherein θ represents an angle between the major axis of the particulate dispersed phase and the X-axis of the film (when the major axis and the X-axis is parallel to each other, θ=0°), <cos²θ> indicates the average of cos²θ calculated from each dispersed phase particle and is represented by the following formula:

<cos²θ>=∫n(θ)·cos²θ·dθ

wherein n(θ) represents a weight ratio of a dispersed phase particle having an angle θ in the whole dispersed phase particle.

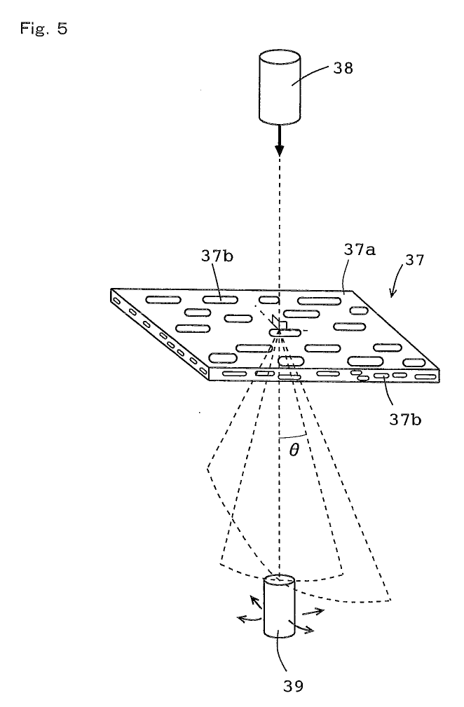

The anisotropic light-diffusing film may be provided with directionality of the diffused or scattered light. That is, this means that the film has an angle giving a maximum scattering intensity when the diffused light has directionality among the angles of intense scattering in anisotropic diffusion. Referring to the measuring system depicted in FIG. 5 described below, the curve by plotting the diffused light intensity F against the diffusion angle θ has a maximum or a shoulder (especially an inflection point such as a maximum) within a given range of diffusion angle θ (angles excluding θ=0°) in the case where the diffused light has directionality. For imparting the directionality to the anisotropic light-diffusing film, the average major axis length of the dispersed phase particle is, for example, about 10 to 100 μM and preferably about 20 to 60 μm.

The thickness of the light-diffusing layer may be about 3 to 500 μm (e.g., about 3 to 300 μm), preferably about 5 to 200 μm (e.g., about 10 to 200 μm), and more preferably 15 to 150 μm (e.g., about 30 to 120 μm).

The light-diffusing film may be a monolayer film comprising the above-mentioned light-diffusing layer alone (for example, an anisotropic light-diffusing layer which diffuses a transmitted light anisotropically) or a laminated (or multilayer) product comprising the light-diffusing layer (for example, an anisotropic light-diffusing layer which diffuses a transmitted light anisotropically) and a transparent layer laminated on at least one side of the light-diffusing layer. Not only a resin layer but also various transparent substrates (for example, a glass) may be used as the transparent layer. The transparent layer is usually formed from a transparent resin. Moreover, in the light-diffusing film having a laminated structure, the transparent resin layer may be laminated on not only one side but also the both sides of the light-diffusing layer.

The transparent resin layer comprises a resin having a high transparency. Such a resin may include, for example, a thermoplastic resin [for example, an olefinic resin, a cyclic olefinic resin, a halogen-containing resin (including a fluorine-containing resin), a vinyl alcohol-series resin, a fatty acid vinyl ester-series resin, a (meth)acrylic resin, a styrenic resin, a polyester-series resin, a polyamide-series resin, a polycarbonate-series resin, a thermoplastic polyurethane resin, a polysulfone-series resin (such as a polyether sulfone or a polysulfone), a poly(phenylene ether)-series resin (such as a polymer of 2,6-xylenol), a cellulose ester, a silicone resin (such as a polydimethylsiloxane or a polymethylphenylsiloxane), and an elastomer (e.g., a rubber such as a nitrile-butadiene copolymer, an acrylic rubber, a urethane rubber, or a silicone rubber, and a thermoplastic elastomer)], and a thermosetting resin (e.g., an epoxy resin, an unsaturated polyester resin, a diallyl phthalate resin, and a silicone resin). The preferred resin includes a thermoplastic resin. The resin having a high transparency may be a non-crystalline (or amorphous) resin.

The olefinic resin may include, for example, a polypropylene-series resin, a copolymer such as a copolymer of an α-C₂₋₆olefin and a copolymerizable monomer [e.g., a copolymer such as an ethylene-vinyl acetate copolymer, an ethylene-vinyl alcohol copolymer, an ethylene-(meth)acrylate copolymer, and an ethylene-(meth)acrylic acid copolymer or a salt thereof (e.g., an ionomer resin)]. The cyclic olefinic resin may include, for example, a homo- or copolymer of a cyclic olefin (such as norbornene or dicyclopentadiene) (e.g., a polymer having a sterically inflexible alicyclic hydrocarbon group (such as tricyclodecane)), and a copolymer of the above-mentioned cyclic olefin and a copolymerizable monomer (e.g., an ethylene-norbornene copolymer and a propylene-norbornene copolymer). Incidentally, the polypropylene-series resin for the transparent resin layer may be different from the polypropylene-series resin for the light-diffusing layer in species, molecular weight and distribution thereof, melt flow rate, or the like; or these polypropylene-series resins may be the same kind of resin, or the same series resin having a common copolymerizable component in part of the copolymerizable components (or the same resin).

The halogen-containing resin may include a vinyl halide-series resin [for example, a homopolymer of a halogen-containing monomer (such as a poly(vinyl chloride) or a poly(vinyl fluoride)) and a copolymer of a halogen-containing monomer and a copolymerizable monomer (such as a vinyl chloride-vinyl acetate copolymer or a vinyl chloride-(meth)acrylate copolymer)], a vinylidene halide-series resin [e.g., a copolymer of a halogen-containing vinylidene monomer and another monomer (such as a vinylidene chloride-(meth)acrylate copolymer)], and others.

The fatty acid vinyl ester-series resin may include, for example, a homo- or copolymer of a vinyl ester-series monomer (e.g., a poly(vinyl acetate)), a copolymer of a vinyl ester-series monomer and a copolymerizable monomer (e.g., a vinyl acetate-ethylene copolymer, a vinyl acetate-vinyl chloride copolymer, and a vinyl acetate-(meth)acrylate copolymer), or a derivative thereof. The derivative of the fatty acid vinyl ester-series resin may include a poly(vinyl alcohol), an ethylene-vinyl alcohol copolymer, a poly(vinyl acetal) resin, and others.

The (meth)acrylic resin to be used may include a homo- or copolymer of a (meth)acrylic monomer, and a copolymer of a (meth)acrylic monomer and a copolymerizable monomer. The (meth)acrylic monomer may include, for example, (meth)acrylic acid; a C₁₋₁₀alkyl(meth)acrylate such as methyl(meth)acrylate, ethyl(meth)acrylate, butyl (meth)acrylate, or 2-ethylhexyl(meth)acrylate; a hydroxyalkyl(meth)acrylate; glycidyl(meth)) acrylate; (meth)acrylonitrile; and a (meth)acrylate having an alicyclic hydrocarbon group such as tricyclodecyl group. The copolymerizable monomer may include a styrenic monomer, and others. These monomers may be used singly or in combination.

The (meth) acrylic resin may include, for example, a poly(meth)acrylate such as a poly(methyl methacrylate), a methyl methacrylate-(meth)acrylic acid copolymer, a methyl methacrylate-(meth)acrylate copolymer, a methyl methacrylate-acrylate-(meth)acrylic acid copolymer, and a methyl(meth)acrylate-styrene copolymer (e.g., an MS resin). The preferred (meth)acrylic resin includes a methyl methacrylate-series resin containing methyl methacrylate unit as a main unit (about 50 to 100% by weight and preferably about 70 to 100% by weight).

The styrenic resin may include a homo- or copolymer of a styrenic monomer (e.g. a polystyrene, a styrene-α-methylstyrene copolymer, and a styrene-vinyl toluene copolymer), and a copolymer of a styrenic monomer and other polymerizable monomers [e.g., a (meth)acrylic monomer, maleic anhydride, a maleimide-series monomer, and a diene]. The styrenic copolymer may include, for example, a styrene-acrylonitrile copolymer (AS resin), a copolymer of styrene and a (meth)acrylic monomer [e.g., a styrene-(meth)acrylate copolymer such as a styrene-methyl methacrylate copolymer, a styrene-methyl methacrylate-(meth)acrylate copolymer, or a styrene-methyl methacrylate-(meth)acrylic acid copolymer], and a styrene-maleic anhydride copolymer. The preferred styrenic resin includes a polystyrene, a copolymer of styrene and a (meth)acrylic monomer [e.g., a copolymer comprising styrene and methyl methacrylate as main units, such as a styrene-methyl methacrylate copolymer], an AS resin, a styrene-butadiene copolymer, and the like.

The polyester-series resin may include an aromatic polyester [for example, a homopolyester, e.g., a poly(C₂₋₄alkylene terephthalate) such as a poly(ethylene terephthalate) or a polybutylene terephthalate), a poly(C₂₋₄alkylene naphthalate), and a copolyester comprising a C₂₋₄alkylene arylate unit (a C₂₋₄alkylene terephthalate unit and/or a C₂₋₄alkylene naphthalate unit) as a main component (e.g., not less than 50% by mol, preferably about 75 to 100% by mol, and more preferably about 80 to 100% by mol)]. The copolyester may include a copolyester in which one or some of C₂₋₄alkylene glycols is substituted with a poly(oxy C₂₋₄alkylene glycol), a C₆₋₁₀alkylene glycol, an alicyclic diol (e.g., cyclohexane dimethanol and hydrogenated bisphenol A), a bisphenol A, and a bisphenol A-alkylene oxide adduct) or the like, and a copolyester in which one or some of aromatic dicarboxylic acids as constituting units is substituted with an unsymmetric aromatic dicarboxylic acid such as phthalic acid or isophthalic acid., an aliphatic C₆₋₁₂dicarboxylic acid such as adipic acid, or the like. The polyester-series resin may also include a polyarylate-series resin, an aliphatic polyester obtainable from an aliphatic dicarboxylic acid such as adipic acid, and a homo- or copolymer of a lactone such as ε-caprolactone. The preferred polyester-series resin is usually a non-crystalline (or amorphous) resin, such as a non-crystalline (or amorphous) copolyester (e.g., a C₂₋₄alkylene arylate-series copolyester).

The polyamide-series resin may include an aliphatic polyamide (e.g., a polyamide 6, a polyamide 66, a polyamide 610, a polyamide 612, a polyamide 11, and a polyamide 12), a polyamide obtainable from a dicarboxylic acid (such as terephthalic acid, isophthalic acid, or adipic acid) and a diamine (such as hexamethylenediamine or m-xylylenediamine) [e.g., a xylylenediamine adipate (MXD-6)], in which at least one of the dicarboxylic acid and the diamine is an aromatic compound, and others. The polyamide-series resin may be a homo- or copolymer of a lactam (e.g., ε-caprolactam). The polyamide-series resin may be either a homopolyamide or a copolyamide.

The polycarbonate-series resin may include the same resin as described above. Incidentally, the polycarbonate-series resin for the transparent resin layer may be different from the polycarbonate-series resin for the light-diffusing layer in species, molecular weight, melt flow rate, or the like. The use of the polycarbonate-series resin of the same kind or the same series (or the same) resin having a common skeleton as the polycarbonate-series resin for the light-diffusing layer sometimes improves the adhesiveness of the transparent resin layer to the light-diffusing layer. The polycarbonate-series resin preferably includes a polycarbonate-series resin containing a bis(hydroxyaryl) C₁₋₆alkane (such as bisphenol A) as a base unit.

The cellulose ester may include, for example, an aliphatic organic acid ester (e.g., a cellulose acetate such as a cellulose diacetate or a cellulose triacetate; an ester of a C₁₋₆organic acid with a cellulose, such as a cellulose propionate, a cellulose butyrate, a cellulose acetate propionate, or a cellulose acetate butyrate), and an aromatic organic acid ester (e.g., an ester of a C₇₋₁₂aromatic carboxylic acid with a cellulose, such as a cellulose phthalate or a cellulose benzoate), and may be an ester of a mixed acid with a cellulose, such as a cellulose acetate nitrate.

The preferred component for the transparent resin layer includes an olefinic resin, a (meth)acrylic resin, a styrenic resin, a polyester-series resin, a polyamide-series resin, a polycarbonate-series resin, and others. The preferred transparent resin layer may comprise a polycarbonate-series resin. The resin to be used for the transparent resin layer may be the same as or different from the resin for the continuous phase and/or the dispersed phase for the light-diffusing layer as long as the adhesiveness or mechanical properties are not deteriorated. The preferred resin for the transparent resin layer usually includes the same or common (or the same series) resin as the resin for the continuous phase.

The transparent resin for the transparent resin layer is preferably a heat-resistant resin (for example, a resin having a high glass transition temperature or melting point), a crystalline resin, and others, for improvement of the heat resistance or antiblocking property. The glass transition temperature or melting point of the resin for the transparent resin layer may be, for example, about 130 to 280° C., preferably about 140 to 270° C., and more preferably about 150 to 260° C.

Further, the transparent resin layer may contain a conventional additive, for example, a stabilizer (e.g., an antioxidant, an ultraviolet ray absorbing agent, a heat stabilizer, and a light stabilizer), a plasticizer, an antistatic agent, and a flame retardant. In particular, the transparent layer preferably comprises a resin layer containing stabilizers (an antioxidant, an ultraviolet ray absorbing agent, a light stabilizer), preferably at least one component selected from the group consisting of an ultraviolet ray absorbing agent and a light stabilizer (an ultraviolet ray absorbing agent alone, a light stabilizer alone, and both an ultraviolet ray absorbing agent and a light stabilizer), particularly a resin layer containing an ultraviolet ray absorbing agent and a light stabilizer. The same component as described above may be used as the stabilizer. The amount to be used of each stabilizer and the total amount of the stabilizer relative to 100 parts by weight of the resin component for the transparent resin layer may be selected from the same range as the range of the ratio of the stabilizer relative to the resin component constituting the light-diffusing layer. Moreover, in a combination use of the ultraviolet ray absorbing agent and the light stabilizer, the ratio of the both components [the former/the latter (weight ratio)] may be selected from the range of about 95/5 to 50/50 (e.g., about 90/10 to 70/30).

The thickness of each transparent resin layer may be at the same level as the thickness of the light-diffusing layer. For example, when the thickness of the light-diffusing layer is 3 to 300 the thickness of the transparent resin layer may be selected from the range of about 3 to 150 μm. The ratio of the thickness of the light-diffusing layer relative to that of each transparent resin layer (the light-diffusing layer/the transparent resin layer) is, for example, about 5/95 to 99/1, preferably about 30/70 to 99/1, and more preferably about 40/60 to 95/5. The thickness of the laminated film may be, for example, about 6 to 600 μm, preferably about 10 to 400 μm, and more preferably about 20 to 250 μm.

Incidentally, the conventional diffusing plate has a thickness of several millimeters. The present invention can provide effective diffusion of a light and improve a luminance of a display apparatus (or a display surface luminance) with using not such a thick diffusing plate but a thin sheet having a thickness of even several tens micrometers. In particular, the use of the anisotropic light-diffusing film can effectively improve a luminance of a display apparatus (or a display surface luminance) in spite of a use of the film for a backlight type liquid crystal display apparatus equipped with a tubular light source.

The total light transmittance of the light-diffusing film (or the light-diffusing layer) may be, for example, not less than 50% (e.g., about 50 to 100%), preferably not less than 60% (e.g., about 60 to 100%), and particularly about 70 to 95% (e.g., about 75 to 90%). Further, the haze value of the light-diffusing film (or the light-diffusing layer) is not less than 80% (e.g., about 80 to 99.9%), preferably not less than 90% (e.g., about 90 to 99.8%), more preferably about 93 to 99.5%, and particularly about 95 to 99%. A low total light transmittance of the light-diffusing film (or the light-diffusing layer) tends to decrease the luminance, and a low haze value of the light-diffusing film (or the light-diffusing layer) prevents uniform diffusion of alight and deteriorates the display quality level.

Incidentally, as long as the optical properties of the light-diffusing film are not deteriorated, a mold-release agent (releasing agent), such as silicone oil, may be applied on a surface of the light-diffusing film or a corona discharge treatment may be given or applied thereto. Further, the light-diffusing film may have an uneven portion extending in X-axis direction of the film (the major-axis direction of the dispersed phase). Such an uneven portion can impart a higher anisotropic light scattering property to the film.

FIG. 2 represents a schematic sectional view illustrating an example of an anisotropic light-diffusing film. An anisotropic light-diffusing film 17 having a monolayer structure comprises a plurality of resins with different refractive indexes and has a phase separation structure (or an islands-in-the-sea structure) comprising a continuous phase 17a and a particulate dispersed phase 17b dispersed therein.

FIG. 3 represents a schematic sectional view illustrating another example of an anisotropic light-diffusing film. In this example, a light-diffusing film 28 has a laminated (or multilayer) structure comprising a light-diffusing layer 27 and a transparent resin layer 29 laminated on at least one side of the light-diffusing layer. Moreover, the light-diffusing layer 27 comprises a plurality of resins with different refractive indexes and has a phase separation structure (or an islands-in-the-sea structure) comprising a continuous phase 27a and a particulate dispersed phase 27b dispersed therein. In the anisotropic light-diffusing film having such a laminated structure, the transparent resin layer 29 can protect the light-diffusing layer 27 to inhibit falling off or adhesion of the dispersed phase particle, and therefore the abrasion-resistance or the stable production of the film is improved and the strength or handleability (or handling property) of the film is heightened.

FIG. 4 represents a schematic diagram for explaining anisotropy of light scattering. As illustrated in FIG. 4, an anisotropic light-diffusing film 37 comprises a continuous phase 37a comprising a resin and a dispersed phase 37b which is dispersed in the continuous phase and has an anisotropic shape. With respect to anisotropy of light scattering, in the light-scattering characteristic F(θ) which represents a relationship between a scattering angle θ and a scattered light intensity F, each of the light-scattering characteristic Fx(θ) and Fy(θ) is attenuated (or decayed) with increasing the scattering angle θ, where Fx(θ) represents the light-scattering characteristic in the X-axis direction of the film, and Fy(θ) represents the light-scattering characteristic in the Y-axis direction perpendicular to the X-axis direction. Moreover, in the range of the scattering angle θ of 4 to 30°, the ratio of Fy(θ) relative to Fx(θ) [the value of Fy(θ)/Fx(θ)] is not less than 1.01, for example, about 1.01 to 200 and preferably about 1.1 to 150. Further, at the scattering angle θ of 18°, the ratio of Fy(θ) relative to Fx(θ) [the value of Fy(θ)/Fx(θ)] is more than 20 to not more than 400 (e.g., more than 20 to mot more than 100), preferably more than 20 to not more than 80, and more preferably more than 20 to not more than 50 (particularly, about 21 to 50).

Use of the anisotropic light-diffusing film, which has such optical characteristics, of the present invention can achieve elimination of a lamp image (a recognizable image of a bar light source itself) with keeping the deterioration of the luminance to a minimum by disposing the film so that a light may be scattered at a direction perpendicular to the axial direction of the bar light source. Incidentally, when the value of Fy(θ)/Fx(θ) and the value of Fy(θ)/Fx(θ) at the scattering angle θ of 18° are excessively large, the appearance of the lamp image can be inhibited while the luminance is significantly deteriorated; on the other hand, when these values are excessively small, the deterioration of the luminance can be inhibited while the lamp image appears.

For preparation of a film having such light-scattering characteristics, the selection of components (particularly, resins) for the continuous phase and the dispersed phase and the molding conditions (particularly, the extrusion temperature, the draw ratio and cooling temperature after molding) are key factors. The film having the light-diffusing characteristic of the present invention is produced using the species of the components described below under the conditions described below.

Incidentally, the X-axis direction of the anisotropic light-diffusing film 37 is usually the same as (or parallel with) the major-axis direction of the dispersed phase 37b. The anisotropic light-diffusing film is, therefore, disposed in such manner that the X-axis direction thereof is almost perpendicular to the axial direction (Y-axis direction) of the tubular light source of the plane light source unit. It is unnecessary that the X-axis direction of the anisotropic light-diffusing film is exactly perpendicular to the axial direction (Y-axis direction) of the tubular light source of the plane light source unit, and for example, the anisotropic light-diffusing film may be disposed in such manner that the X-axis direction thereof is oriented to the Y-axis direction of the tubular light source with an angle of inclination within an angle range of about ±15° (e.g., about ±10°, particularly about)±5°.

The light-scattering characteristic F(θ) can be, for example, measured using an instrument as shown in FIG. 5. This instrument comprises a laser irradiating unit (e.g., Nihon Kagaku Eng., NEO-20MS) 38 for projecting a laser light to the anisotropic light-diffusing film 37 and a detector 39 for quantitating the intensity of the laser light transmitted through the anisotropic light-diffusing film 37. The laser light is emitted at an angle of 90° with respect to (perpendicular to) the light-diffusing film 37 and the intensity F of the light diffused by the film (diffusion intensity) is measured or plotted against the diffusing angle θ, whereby the light-scattering characteristic can be determined.

When the anisotropy of the light scattering of the anisotropic light-diffusing film is higher, the angle dependence of the scattering in a given direction can be lower. Therefore, the angle dependence of the luminance can be also lower. In a use of the anisotropic light-diffusing film, assuming that an angle which is perpendicular)(90° to the display surface is 0°, the luminance can be prevented from decreasing even at the angle of not less than 40°, over that of 20°, on the display surface.

[Process for Producing Light-Diffusing Film]

The light-diffusing film can be prepared by dispersing the resin component for the dispersed phase in the resin for the continuous phase. The anisotropic light-diffusing-film can be obtained by deforming and orienting the resin component for the dispersed phase. For example, the dispersed phase can be dispersed in the continuous phase by blending the polycarbonate-series resin and the polypropylene-series resin, and if necessary the compatibilizing agent or other components in the conventional manner (e.g., melt-blending methods, tumbler methods, etc.) where necessary, melt-mixing the blended matter, and extruding the molten mixture from a T-die, a ring die, or the like into a film form. Moreover, the light-diffusing-film can also be produced by forming with the use of the conventional film-forming method, for example, a coating method which comprises applying a composition comprising a particulate polypropylene-series resin as a light-scattering component and a polycarbonate-series resin on a substrate (e.g., a substrate film), a laminating method which comprises laminating the composition, a casting method, and an extrusion molding method. The light-diffusing film is usually formed by the extrusion molding method.

Incidentally, a light-diffusing film which has a laminated structure, comprising a light-diffusing layer and a transparent resin layer laminated on at least one side of the light-diffusing layer, may be formed by a co-extrusion molding method comprising co-extruding a resin composition comprising a component corresponding to the light-diffusing layer and a resin composition comprising a component corresponding to the transparent resin layer to form a film; a method comprising laminating one layer on previously produced another layer with extruding lamination; a dry lamination method comprising laminating a produced light-diffusing layer and a produced transparent resin layer, and others.

The isotropic light-diffusing film may be prepared by extrusion molding under the above-mentioned condition (for example, drawing at a small draw ratio, extrusion molding under a mild condition such as unstretching treatment) and heating treatment the resulting film after extrusion molding (for example, heating treatment for relaxing deformation of the dispersed phase caused by the extrusion) to relax the shape of the dispersed phase into a spherical shape.

With respect to the anisotropic light-diffusing layer, the orientation of the dispersed phase can be achieved by, for example, (1) a method comprising drafting (or drawing) the extruded sheet to form the sheet in the course of extrusion, (2) a method comprising stretching the extruded sheet uniaxially, (3) a combination of the methods (1) and (2), (4) a method which comprises mixing these components described above together in solution and forming the sheet from the mixture by a casting method.

The melting temperature may be, for example, about 150 to 270° C., preferably about 200 to 260° C., and more preferably about 230 to 255° C.

To impart adequate anisotropy to the light-diffusing film of the present invention, the film is preferably obtained by drafting (or drawing) the extruded sheet to form the sheet in the course of extrusion in melt-molding process. To express a predetermined anisotropic light-diffusing characteristic, the adjustment of the draw ratio after extrusion is important. The draw ratio (draft) may be selected from the range of about 1.5 to 50 depending on the opening of the die of extruder, the species of the resin, the layered structure, and others. In the monolayer film the draw ratio may be, for example, selected from about 4 to 40, preferably about 5 to 35, and more preferably about 8 to 30 (particularly about 10 to 25) so that the anisotropic parameters may be in the above-mentioned range. In a laminated film, which tends to have an increased anisotropy compared with a monolayer film, the draw ratio may be, for example, about 3.5 to 20, preferably about 4 to 18, and more preferably about 5 to 16 (particularly about 6 to 15).

The cooling temperature using a cast roller or the like may be, for example, about 30 to 110° C., preferably about 40 to 100° C., and more preferably about 60 to 90° C. Further, the light-diffusing film of the present invention may be stretched (uniaxially or biaxially stretched, particularly uniaxially stretched). The stretching ratio of the light-diffusing film may be selected depending on the aspect ratio of the dispersed phase. The stretching ratio at one direction may be, for example, about 1.1 to 10, preferably about 1.2 to 5, and more preferably about 1.5 to 3.

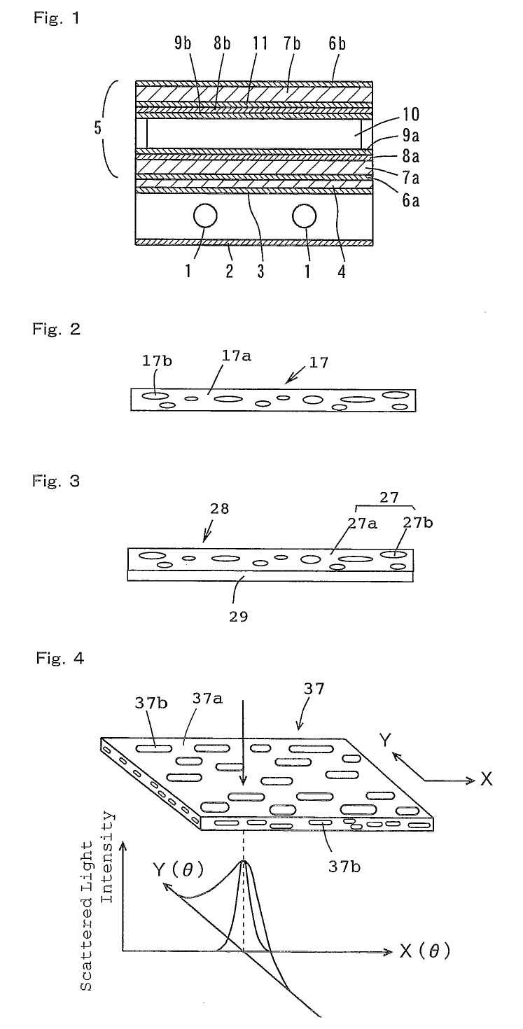

In the light-diffusing film of the present invention, a transmitted light is scattered and diffused due to the difference in refractive index between the continuous phase and the dispersed phase. In particular, a larger aspect ratio of the dispersed phase brings anisotropic diffusion to the light. Therefore, the light-diffusing film of the present invention is available for various optical applications. For example, in spite of a use of a local light source, the isotropic light-diffusing film can diffuse a transmitted light from the light source to give a uniform luminance. In particular, in spite of a use of a tubular light source providing an anisotropic luminance, the anisotropic light-diffusing film can diffuse a transmitted light from the light source to give a uniform luminance. Therefore, application of the light-diffusing film of the present invention to a display apparatus (such as a liquid crystal display apparatus) allows a uniform illumination of the whole display surface. Accordingly, the light-diffusing film of the present invention is useful as a component part for a plane light source device or a display apparatus (for example, a display apparatus having a flat area for displaying an image (a flat-screen display apparatus), such as a liquid crystal display apparatus). Taking a liquid crystal display apparatus as an example, the following will be described with reference to the above-mentioned FIG. 1.

[Liquid Crystal Display Apparatus]

In FIG. 1 illustrating the outline of a liquid crystal display apparatus, the liquid crystal display apparatus comprises a plane or flat display unit (such as a transmissive liquid crystal display unit or a liquid crystal display panel) 5 as a member to be illuminated, and a plane or flat light source unit for illuminating the display unit 5. The plane or flat display unit 5 comprises a liquid crystal cell having a liquid crystal sealed therein, and the plane or flat light source unit is disposed behind the display unit (or panel).

The plane or flat light source unit comprises one or a plurality of tubular light source(s) (e.g., a fluorescent discharge tube (cold cathode tube)) 1 directly under the display unit 5, and a reflector 2 for reflecting a light from the tubular light source 1 to the front or forward direction (the side of the display unit) to guide the light to the display unit 5. The plurality of tubular light sources is disposed in parallel with each other. The plane or flat light source unit further comprises a supporting plate (not shown) disposed in the front or forward direction of the tubular light source 1, a diffusing plate (for example, an anisotropic light-diffusing film) 3 for scattering a transmitted light anisotropically, and a prism sheet 4. The diffusing plate 3 is located at an emitting surface side of the supporting plate (a light-emitting surface side of the plane light source unit); and the prism sheet 4 is located at a display surface side of the anisotropic light-diffusing film 3 and has small prisms (prism units), each having a triangular cross section, formed in parallel with each other in a predetermined direction. The supporting plate, the diffusing plate, and the prism sheet are laminated in that order. The light from the tubular light source 1 is diffused and uniformized by the anisotropic light-diffusing film 3 and is focused forward by the prism sheet 4, and the luminance is improved to illuminate the display unit 5. Incidentally, the supporting plate is a transparent plate which is formed for protecting the anisotropic light-diffusing film 3, which is a thin film.

Incidentally, the plane or flat display unit (liquid crystal display unit) 5 comprises a first polarizing film 6a, a first glass substrate 7a, a first electrode 8a formed on the glass substrate, a first orientation layer 9a laminated on the electrode, a liquid crystal layer 10, a second orientation layer 9b, a second electrode 8b, a color filter 11, a second glass substrate 7b, and a second polarizing film 6b as successively built up (laminated) in that order.

In such a display apparatus, the display unit can directly be illuminated from the back side by the tubular light source 1 (e.g., a built-in fluorescent tube (cold cathode tube)). Therefore, the backlight type plane light source device using a tubular light source (lamp) has become important for a liquid crystal display apparatus along with the increase in display size of a liquid crystal television in recent years.

However, the luminance distribution of a light emitted (or emerged) from the tubular light source 1 is usually not uniform, that is, the luminance distribution in the direction perpendicular to the axis direction of the tubular light source 1 is not uniform. In particular, the tubular light source itself disposed directly under the display unit (liquid crystal display unit) 5 is recognized from the display surface side, and the lamp image appears on the display surface. Therefore, it is necessary to uniformize the display surface luminance in a use of the tubular light source. In particular, since the anisotropic light-diffusing film 3 is disposed adjacent to the tubular light source 1, the anisotropic light-diffusing film 3 requires a stable light-diffusing property over a long period of time.

Moreover, a use of the anisotropic light-diffusing film 3 for a backlight type plane light source unit or a liquid crystal display apparatus can make the display surface luminance uniform and inhibit an appearance (or generation) of the lamp image. That is, when the anisotropic light-diffusing film 3 is disposed so that the major-axis direction of the dispersed phase is parallel with the major-axis direction of the tubular light source 1, a light from the tubular light source (fluorescent tube) 1 can be scattered in the direction perpendicular to the length direction of the bar light source due to the anisotropic light scattering property. Accordingly, the anisotropic light-diffusing film can make the emitting surface luminance uniform with keeping the deterioration of the luminance to a minimum and achieve uniform illumination to the display surface. Moreover, due to the anisotropic light scattering, the lamp image by which the tubular light source 1 itself is recognized can be eliminated. Further, in spite of the anisotropic light-diffusing film of several tens micrometers (about 0.2 mm) thinness, a display surface luminance of a backlight type liquid crystal display apparatus can be improved. Furthermore, a large-screen liquid crystal display apparatus can be thinned by a use of the anisotropic light-diffusing film, and the apparatus can be easily produced. That is, the anisotropic light-diffusing film of the present invention can achieve a high-luminance and uniform illumination of a display surface of a large-screen liquid crystal display apparatus, even when the thickness of the film is small. In particular, since each of the continuous phase and the dispersed phase comprises the predetermined resin, the film has a high heat resistance. Therefore, even when the film is used for a direct plane light source unit, in which the film is located near the tubular light source 1 and exposed to a high temperature, a predetermined anisotropic light diffusion can be maintained over a long period of time.

Incidentally, in the liquid crystal display apparatus, an isotropic light-diffusing film may be used instead of the anisotropic light-diffusing film. Further, it is sufficient that the light-diffusing film (e.g., the anisotropic light-diffusing film) is disposed into a light path emerged from the light-emitting (emerging) surface (the emitting surface) of the plane light source unit, that is, disposed between the plane light source unit and the display unit. If necessary, the light-diffusing film may be disposed, in the form laminated, on the light-emitting (emerging) surface with the use of an adhesive. More specifically, the light-diffusing film (e.g., the anisotropic light-diffusing film) may be disposed in the light-emitting surface side of the plane light source unit or in the light-Incident surface side of the display unit; or may be disposed between the emitting surface of the plane light source unit and the display unit. Incidentally, it is unnecessary to laminate the light-diffusing film on the emitting surface of the plane light source unit. Moreover, although it is unnecessary to use the prism sheet or the luminance (or brightness) enhancement sheet in combination, the prism sheet is useful for focusing a diffused light and illuminating the display unit. In a combination use of the prism sheet and the light-diffusing film, the prism sheet may usually be disposed in a downstream side of the light path with respect to the light-diffusing film. Moreover, the light-diffusing film may be used in combination with an optical retardation film, a polarizing film, a color filter, and the like (for example, in a lamination manner).

Further, in the plane light source unit, it is unnecessary to dispose the tubular light source directly under the display unit. The tubular light source may be located at the lateral of the display unit. In this case, a light emitted from the tubular light source located at the lateral of the display unit enters the lateral side of the light guide plate, and the entered light is emitted from the emitting surface of the light guide plate (the surface opposed to the display unit). The display unit may be illuminated in this manner. Moreover, the number of tubular light sources is not particularly limited to a specific one and may be selected according to the display surface size, or others.

Incidentally, the X-axis direction of the anisotropic light-diffusing film is usually the same direction as (or parallel with) the major-axis direction of the dispersed phase. The anisotropic light-diffusing film is, therefore, disposed in such manner that the X-axis direction thereof is almost perpendicular to the axial direction (Y-axis direction) of the tubular light source of the plane light source unit. It is unnecessary that the X-axis direction of the anisotropic light-diffusing film be exactly perpendicular to the axial direction (Y-axis direction) of the tubular light source of the plane light source unit, and for example, the anisotropic light-diffusing film may be disposed in such manner that the X-axis direction thereof is oriented to the Y-axis direction of the tubular light source with an angle of inclination within an angle range of about ±15° (e.g., about ±10°, particularly about ±5°).

### INDUSTRIAL APPLICABILITY

The light-diffusing film of the present invention has a high heat resistance, inhibits a change in a light-scattering characteristic over a long period of time even when used under a high temperature, and allows a display unit to be illuminated uniformly using a backlight unit (a plane light source unit). Therefore, the film is useful for a member for a display apparatus (e.g., a liquid crystal display apparatus) or a backlight type light source apparatus (a plane light source device). In particular, since a direct backlight unit (a plane light source unit), in which a light source is disposed directly under a display unit, can be adaptable for display apparatuses having various screen sizes, particularly, a large-sized screen display unit, the film is suitable for a component member for such a large-sized screen display unit or backlight unit. The screen size of the display unit is not particularly limited to a specific one, and may be, for example, not smaller than 20 inches (e.g., about 23 to 300 inches and preferably about 30 to 200 inches).

### EXAMPLES

Hereinafter, the following examples are intended to describe this invention in further detail and should by no means be interpreted as defining the scope of the invention. Incidentally, characteristics of anisotropic light-diffusing films used in Examples and Comparative Examples and plane light source devices provided with the films were evaluated according to the following methods.

[Total Light Transmittance TT (%) and Haze (%)]

The total light transmittance and the haze were measured by a haze meter (manufactured by Nippon Denshoku Industries Co., Ltd., NDH-500) in accordance with JIS K 7301.

[Aspect Ratio]

The cross section of the anisotropic light-diffusing film was observed by a transmission electron microscope (TEM). For five dispersed phase particles, the major axis length of each particle and the minor axis length thereof were measured, and the average aspect ratio was calculated from the averaged value of the major axis length and that of the minor axis length.

[Degree of Anisotropy]

Using the measuring system illustrated in FIG. 5, the scattered light intensity F at the scattering angle θ was measured. Incidentally, the stretching direction of the anisotropic light-diffusing film was designated as X-axis direction, and the direction perpendicular to the stretching direction was designated as Y-axis direction. The value of R(θ)=Fy(θ)/Fx(θ) at the scattering angle θ of 18° is shown as the degree of anisotropy in Table 1.

[Quantitative Evaluation of Front Luminance of Plane Light Source Device]

For evaluation of front luminance, a direct light source device was made by rebuilding a commercially available liquid crystal TV having a direct light source device in a back side thereof (manufactured by Mitsubishi Electric Corporation, REAL-LCD-H32MX60). The anisotropic light-diffusing film was disposed so that the Y direction of the film was approximately perpendicular to the longitudinal direction of the cold cathode tube, and a prism sheet was disposed on the anisotropic light-diffusing film so that the prism array was parallel with the longitudinal direction of the cold cathode tube. The luminance was measured at 100 points which were positioned at the equal intervals on the center line of the light source device in the lateral direction of the cold cathode tube using a luminance meter (manufactured by Konica Minolta Holdings, Inc., LS-110), and the averaged value of the luminance was determined as the front luminance.

[Heating Treatment]

A liquid crystal cell unit was removed from a commercially available 15-inch transmissive liquid crystal display apparatus and dismantled. The apparatus has had a diffusing sheet, a prism sheet, a protective sheet, and a backlight part comprising a light guide plate, and the diffusing sheet, the prism sheet, and the protective sheet being disposed in an upper side of the light guide plate in this order. Each one of anisotropic light-diffusing films obtained in Examples and Comparative Examples was disposed in stead of the protective sheet, and a backlight unit (a plane light source unit) which did not comprise a liquid crystal cell was constructed. This backlight unit was heated in a high-temperature oven at the following three conditions: 70° C. for 30 minutes, 90° C. for 30 minutes, and 110° C. for 30 minutes. The sheets subjected to these heat treatments were used for the following evaluations of luminance unevenness and deformation.

[Luminance unevenness (Mura)]

In a backlight unit removed from a transmissive liquid crystal display apparatus, each one of anisotropic light-diffusing films obtained in Examples and Comparative Examples was disposed instead of a protective sheet, and the backlight unit was turned on. The luminance unevenness (mura) of the backlight unit surface was visually observed from the front side and estimated or determined on the basis of the following criteria. The luminance unevenness test was conducted for both the initial (or untreated) anisotropic light-diffusing film and the anisotropic light-diffusing film subjected to the above heat treatment. Incidentally regarding the test for the anisotropic light-diffusing film subjected to the heat treatment, lighting the backlight unit after the heat resistance test was carried out immediately after heating (immediately after setting the sheet aside from the high-temperature oven), and the backlight unit was visually observed under circumstances at almost the same temperature with the temperature of the heat resistance test.

A: no luminance unevenness

B: slight luminance unevenness

C: significant luminance unevenness

[Deformation of Anisotropic Light-Diffusing Film]

After subjecting the film to the heat treatment, the film was allowed to cool. The backlight unit was disassembled and the anisotropic scattering sheet was removed from the backlight unit. The deformation (change in shape) of the anisotropic light-diffusing film was visually evaluated in accordance with the following criteria:

A: no wrinkle

B: a slight number of wrinkles (the number of wrinkles: 1 to 2)

C: a large number of wrinkles (the number of wrinkles: not less than 3)

[Lamp Image]

In the transmissive liquid crystal display apparatus used for the luminance unevenness test, whether or not an image of a straight fluorescent tube (lamp) used as the backlight light source could be visually observed through the anisotropic light-diffusing film was evaluated on the basis of the following criteria.

A: no lamp image

B: slight lamp image

C: clear lamp image

### Example 1

The following components were mixed together: 84 parts by weight of a bisphenol A-based polycarbonate-series resin (manufactured by Mitsubishi Engineering-Plastics Corp., “Medium-viscosity product IUPILON S-2000”, the number average molecular weight of 18000 to 20000, the melt flow rate of 9 to 12 g/10 minutes) as a resin for a continuous phase, 16 parts by weight of a polypropylene-series resin (manufactured by Japan Polypropylene Corporation, “WINTEC WFX-4”, a metallocene-catalyzed propylene-series random copolymer, the melt flow rate of 7 g/10 minutes) as a resin for a dispersed phase, 0.1 parts by weight of an antioxidant (a hindered phenol-series antioxidant, manufactured by Ciba Japan K.K., “IRGANOX 1010”), and 0.5 parts by weight of an ultraviolet ray absorbing agent (a benzotriazole-series ultraviolet ray absorbing agent, manufactured by Ciba Specialty Chemicals K.K., “TINUVIN 234”). The mixture was melt-extruded from a die having an opening of 1.3 mm using an extruder at a resin temperature of 250° C. and cooled with a draw ratio (draft) of 19 using three cast rollers controlled to 80° C. by an oil temperature controller to produce an anisotropic light-diffusing film having a thickness of 90 μm. Observation of the cross section of the light-diffusing film with a transmission electron microscope (TEM) revealed that the polypropylene formed a scatterer (a particulate dispersed phase) having an elliptical (or oval sphere) shape (or elongate shape), an average minor axis length (thickness) of 0.09 μm, and an average major axis length of 700 μm (aspect ratio of 7800).

### Example 2

In order to produce a three-layered light-diffusing plate comprising two kinds materials (a light-diffusing plate comprising an anisotropic light-diffusing layer as an intermediate layer and a transparent resin layer as a surface layer laminated on either side of the anisotropic light-diffusing layer), the following resin compositions were used. A resin composition for forming the surface layer comprised 100 parts by weight of a polycarbonate-series resin (manufactured by Mitsubishi Engineering-Plastics Corp., “IUPILON S-2000”), 0.5 parts by weight of an ultraviolet ray absorbing agent (manufactured by Ciba Specialty Chemicals K.K., “TINUVIN 234”), and 0.1 parts by weight of a light stabilizer (a hindered amine-series light stabilizer, “CHIMASSORB 944FD”); and a resin composition for forming the intermediate layer comprised 84 parts by weight of a polycarbonate-series resin as a matrix resin (manufactured by Mitsubishi Engineering-Plastics Corp., “IUPILON S-2000”), 16 parts by weight of a polypropylene-series resin as a resin for a dispersed phase (manufactured by Japan Polypropylene Corporation, “WINTEC WFX-4”), and 0.1 parts by weight of an antioxidant (a hindered phenol-series antioxidant, manufactured by Ciba Japan K.K., “IRGANOX 1010”). These resin compositions for each layer were mixed separately and melt-co-extruded from a die having an opening of 1.3 mm using a multi-layer extruder at a resin temperature of 250° C. and cooled with a draw ratio (draft) of 12 using three cast rollers controlled to 80° C. by an oil temperature controller to produce an anisotropic light-diffusing film having a three-layered structure (thickness ratio=1:3:1) and a thickness of 110 μm. In the intermediate layer of the anisotropic light-diffusing film, the polypropylene-series resin formed a scatterer (a particulate dispersed phase) having an elliptical (or oval sphere) shape (or elongate shape), an average minor axis length of 0.15 μm, and an average major axis length of 700 μm (aspect ratio of 4700).

### Examples 3 to 8

Regarding each Examples, in order to produce a three-layered light-diffusing plate comprising two kinds materials (a light-diffusing plate comprising an anisotropic scattering layer as an intermediate layer and a transparent resin layer as a surface layer laminated on either side of the anisotropic light-diffusing layer), a resin composition comprising 100 parts by weight of a polycarbonate-series resin (manufactured by Mitsubishi Engineering-Plastics Corp., “IUPILONS-2000”) and 0.5 parts by weight of an ultraviolet ray absorbing agent (manufactured by Ciba Specialty Chemicals K.K., “TINUVIN 234”) was used for forming the surface layer, and a resin composition comprising a polycarbonate-series resin as a matrix resin (manufactured by Mitsubishi Engineering-Plastics Corp., “IUPILON S-2000”) and a polypropylene-series resin as a resin for a dispersed phase (manufactured by Japan Polypropylene Corporation, “WINTEC WFX-4”) was used for forming the intermediate layer in a proportion shown in Table 1. To the resin composition for the intermediate layer, 0.1 parts by weight of an antioxidant (a hindered phenol-series antioxidant, manufactured by Ciba Japan K.K., “IRGANOX 1010”) was added. These resin compositions for each layer were mixed separately and melt-co-extruded from a die having an opening of 1.3 mm using a multi-layer extruder at a resin temperature of 250° C. and cooled with a draw ratio (draft) of 12 using three cast rollers controlled to 80° C. by an oil temperature controller to produce an anisotropic light-diffusing film having a three-layered structure (thickness ratio=1:3:1) and a thickness of 110 μm. In the intermediate layer of the anisotropic light-diffusing film, the polypropylene-series resin formed a scatterer (a particulate dispersed phase) having an elliptical (or oval sphere) shape (or elongate shape).

### Comparative Example 1

The following components were used: 91 parts by weight of a crystalline polypropylene-series resin PP (manufactured by Grand Polymer Co., F133, the refractive index of 1.503) as a resin for a continuous phase, 7 parts by weight of a polystyrenic resin GPPS (a general-purpose polystyrenic resin, manufactured by Daicel Chemical Industries, Ltd., GPPS#30, the refractive index of 1.589) as a resin for a dispersed phase, and 1 part by weight of an epoxidized diene-series block copolymer (manufactured by Daicel Chemical Industries, Ltd., EPOFRIEND AT202; styrene/butadiene=70/30 (weight ratio), epoxy equivalent of 750, the refractive index of about 1.57) as a compatibilizing agent. Incidentally, the refractive index difference between these resins is 0.086.

The above continuous and dispersed phase resins were dried at 70° C. for about 4 hours, and the dried resins were kneaded in a Banbury mixer. Using a multi-layered type extruder, the kneaded product for forming a center or intermediate layer and the transparent resin (polypropylene-series resin) for forming a surface layer were melted at about 240° C. and extruded from a T-die with a draw ratio of about 4 onto a cooling or chilling drum (chill roll) having a surface temperature of 25° C. to laminate 60 μm of each of the surfaces (a transparent resin layer: Japan Polychem Corp., copolymer PP “FG-4”) on both sides of 60 μm of the center layer for obtaining a laminated sheet having three-layered structure (total thickness: 180 μm). The both surfaces of the anisotropic scattering film were suitably roughened with applying the chill roll having a mat surface to one side of the sheet and applying a rubber roll having roughened surface to the other side of the sheet (non-chilled side).

Observation of the center layer of the obtained anisotropic light-diffusing film by transmission electron microscopy (TEM) revealed that the form of the dispersed phase in the center layer included from an approximate sphere-like (suborbicular) form (the aspect ratio of about 1 and the average particulate size of about 5 μm) to a rugby ball-like configuration having a small aspect ratio (the aspect ratio of about 4, the average major axis length of about 12 μm, and the average minor axis length of about 3 μm).

### Comparative Example 2

An anisotropic light-diffusing film was produced in the same manner as in Comparative Example 1 and cut into a sheet form. The resulting sheet was heat-treated in a high-temperature oven at 90° C. for 8 hours to give a heat-treated anisotropic light-diffusing film.

The results are shown in Table 1.

TABLE 1

| | | Examples | | | | |
|---|---|---|---|---|---|---|
| | | 1 | 2 | 3 | 4 | 5 |
| Formulation | PC | 84 | 84 | 80 | 80 | 88 |
| (parts by weight) | PP | 16 | 16 | 20 | 20 | 12 |
| | GPPS | — | — | — | — | — |
| | Epoxidized resin | — | — | — | — | — |
| Layer construction | | Monolayer | Two kinds | Two kinds | Two kinds | Two kinds |
| | | | Three-layer | Three-layer | Three-layer | Three-layer |
| Heat treatment | | No | No | No | No | No |
| Total thickness | (μ) | — | 167 | 157 | 209 | 163 |
| Thickness of | (μ) | 90 | 97 | 99 | 126 | 112 |
| scattering layer | | | | | | |
| Optical | TT | 82 | 87 | 83 | 77 | 81 |
| characteristics (%) | HAZE | 97 | 96 | 97 | 99 | 98 |
| Degree of anisotropy | | 260 | 65 | 25 | 4 | 7 |
| Aspect ratio | | 7800 | 4700 | 388 | 6 | 18 |
| Luminance | Initial | A | A | A | A | A |
| unevenness | 70° C., 30 min. | A | A | A | A | A |
| | 90° C., 30 min. | A | A | A | A | A |
| | 110° C., 30 min. | A | A | A | A | A |
| Deformation of | Initial | A | A | A | A | A |
| anisotropic | 70° C., 30 min. | A | A | A | A | A |
| scattering sheet | 90° C., 30 min. | A | A | A | A | A |
| | 110° C., 30 min. | A | A | A | A | A |
| Luminance (cd/cm²) | | 5620 | 5752 | 5896 | — | — |
| Lamp image | | A | A | A | — | — |

| | | Examples | | | Comparative Examples | |
|---|---|---|---|---|---|---|
| | | 6 | 7 | 8 | 1 | 2 |
| Formulation | PC | 92 | 92 | 92 | — | — |
| (parts by weight) | PP | 8 | 8 | 8 | 91 | 91 |
| | GPPS | — | — | — | 7 | 7 |
| | Epoxidized resin | — | — | — | 1 | 1 |
| Layer construction | | Two kinds | Two kinds | Two kinds | Two kinds | Two kinds |
| | | Three-layer | Three-layer | Three-layer | Three-layer | Three-layer |
| Heat treatment | | No | No | No | No | Yes |
| Total thickness | (μ) | 96 | 131 | 167 | 180 | 180 |
| Thickness of | (μ) | 56 | 75 | 97 | 60 | 60 |
| scattering layer | | | | | | |
| Optical | TT | 93 | 91 | 87 | 91 | 91 |
| characteristics (%) | HAZE | 77 | 92 | 96 | 85 | 85 |
| Degree of anisotropy | | 421 | 84 | 15 | 15 | 15 |
| Aspect ratio | | — | — | — | 1 to 4 | 1 to 4 |
| Luminance | Initial | A | A | A | A | A |
| unevenness | 70° C., 30 min. | A | A | A | B | A |
| | 90° C., 30 min. | A | A | A | C | A |
| | 110° C., 30 min. | A | A | A | C | C |
| Deformation of | Initial | A | A | A | A | A |
| anisotropic | 70° C., 30 min. | A | A | A | B | A |
| scattering sheet | 90° C., 30 min. | A | A | A | C | A |
| | 110° C., 30 min. | A | A | A | C | C |
| Luminance (cd/cm²) | | — | — | — | — | — |
| Lamp image | | — | — | — | — | — |

In Table 1, the meanings of abbreviations are as follows.

PC: polycarbonate-series resin, PP: polypropylene-series resin, GPPS: polystyrenic resin, Epoxidized resin: epoxidized diene-series block copolymer, and TT: total light transmittance (%).

### Comparative Example 3

The following resins were mixed together: 80 parts by weight of a polycarbonate-series resin (manufactured by Mitsubishi Engineering-Plastics Corp., “IUPILON S-2000”) as a matrix resin and 20 parts by weight of a cyclic olefinic resin (manufactured by TOPAS ADVANCED POLYMERS, “TOPAS 6015”) as a resin for a dispersed phase. Although the mixture was melt-kneaded and extruded using a biaxial extruder at 280° C., a predetermined pellet could not be obtained due to a large draw resonance.

### Comparative Example 4

In the same manner as in Comparative Example 3 except for using 90 parts by weight of a polycarbonate-series resin (manufactured by Mitsubishi Engineering-Plastics Corp., “IUPILON S-2000”) as a matrix resin and 10 parts by weight of a cyclic olefinic resin (manufactured by TOPAS ADVANCED POLYMERS, “TOPAS 6015”) as a resin for a dispersed phase, the mixture was melt-kneaded and extruded. However, a predetermined pellet could not be obtained due to a large draw resonance.

### Comparative Example 5

In the same manner as in Comparative Example 3 except for using 20 parts by weight of a polycarbonate-series resin (manufactured by Mitsubishi Engineering-Plastics Corp., “IUPILON S-2000”) and 80 parts by weight of a cyclic olefinic resin (manufactured by TOPAS ADVANCED POLYMERS, “TOPAS 6015”), the mixture was melt-kneaded and extruded, and water-cooled to give a pellet of the compound. The pellet was formed into a sheet using an extruder at a resin temperature of 260° C. The resulting sheet had a large number of gels generated. Thus, only an ununiform sheet could be obtained.

### Comparative Example 6

In the same manner as in Comparative Example 3 except for using 75 parts by weight of a polycarbonate-series resin (manufactured by Mitsubishi Engineering-Plastics Corp., “IUPILON S-2000”) and 25 parts by weight of a methyl methacrylate-series resin (manufactured by Mitsubishi Rayon Co., Ltd., “ACRYPET”), the mixture was melt-kneaded and extruded, and water-cooled to give a pellet of the compound. The pellet was formed into a sheet using an extruder at a resin temperature of 260° C. Burn mark was observed in the sheet due to decomposition of the methyl methacrylate-series resin. Thus, only an ununiform sheet could be obtained.

### Comparative Example 7

A commercially available diffusing sheet for a light guide plate (manufactured by Tsujiden Co., Ltd., D123) was used as a comparative example. In addition to an insufficient elimination of the lamp image, a remarkable deterioration of the luminance was observed.

### Example 9

In the same manner as in Example 2 except that the draw ratio (draft) was 8, an anisotropic light-diffusing film having a thickness of 160 μm was produced.

### Comparative Example 8

A commercially available 2-mm thick diffusing plate made of PC (manufactured by Tsutsunaka Plastic Industry Co., Ltd, OPTMAX) was used as a comparative example. Although the lamp image was eliminated, a significant deterioration of the luminance was observed.

### Example 10

In the same manner as in Example 2 except that the draw ratio (draft) was 3, the resin temperature was 280° C., and the cooling temperature by the cast roller was 120° C., an anisotropic light-diffusing film having a thickness of 160 μm was produced.

### Example 11

In the same manner as in Example 2 except that the draw ratio (draft) was 19, an anisotropic light-diffusing film having a thickness of 80 μm was produced.

The results of Comparative Examples 7 to 8 and Examples 9 to 11 are shown in Table 2.

TABLE 2

| | Characteristic factors | | | | Evaluation items | |
|---|---|---|---|---|---|---|
| | Layer | Thickness | Degree of | Total light | Luminance | |
| | construction | (μm) | anisotropy | transmittance (%) | (cd/cm²) | Lamp image |
| Comparative | Monolayer | 125 | 1 | 72 | 5310 | C |
| Example 7 | | | | | | |
| Example 9 | Two kinds | 160 | 25 | 83 | 5896 | A |
| | Three-layer | | | | | |
| Comparative | Monolayer | 2000 | 1 | 55 | 5094 | A |
| Example 8 | | | | | | |
| Example 10 | Two kinds | 160 | 3 | 83 | 5898 | B |
| | Three-layer | | | | | |
| Example 11 | Two kinds | 80 | 430 | 80 | 5613 | B |
| | Three-layer | | | | | |

As apparent from the results shown in Table 2, use of the films produced in Examples provides a high luminance without any remaining lamp image. On the other hand, use of the films produced in Comparative Examples results in the remaining lamp image or the remarkable deterioration of the luminance.

1. A light-diffusing film which comprises a light-diffusing layer comprising
a continuous phase comprising a polycarbonate-series resin and
a dispersed phase comprising a polypropylene-series resin.

2. A light-diffusing film according to claim 1, wherein the polycarbonate-series resin comprises a polycarbonate-series resin having a number average molecular weight of 15000 to 25000, and the polypropylene-series resin comprises a metallocene-catalyzed resin.

3. A light-diffusing film according to claim 1, wherein the light-diffusing layer is substantially free from a compatibilizing agent, and the dispersed phase contains a polypropylene-series random copolymer.

4. A light-diffusing film according to claim 1, wherein the polycarbonate-series resin has a melt flow rate of 5 to 30 g/10 minutes in accordance with ISO1133 (300° C., 1.2 kg load), and the polypropylene-series resin has a melt flow rate of 3 to 20 g/10 minutes in accordance with JIS K7210 (230° C., 2.16 kg load).

5. A light-diffusing film according to claim 1, wherein the light-diffusing layer further contains at least one selected from the group consisting of an antioxidant and an ultraviolet ray absorbing agent.

6. A light-diffusing film according to claim 1, wherein the dispersed phase has an average aspect ratio of larger than 1, contains a particulate dispersed phase of which major-axis direction is oriented to a certain direction of the film, and anisotropically diffuses a transmitted light.

7. A light-diffusing film according to claim 6, wherein the average minor axis length of the particulate dispersed phase is 0.01 to 10 μm, and the average aspect ratio of the particulate dispersed phase is 3 to 20000.

8. A light-diffusing film according to claim 1, which is an anisotropic light-diffusing film capable of scattering an incident light to a traveling direction of the light, and
when F(θ) represents a light-scattering characteristic representing a relationship between a scattering angle θ and a scattered light intensity F, each of Fx(θ) and Fy(θ) is attenuated with increasing the scattering angle θ, and Fx(θ) and Fy(θ) satisfy the following expression in the range of the scattering angle θ of 4 to 30°:
1.01≦Fy(θ)/Fx(θ)
and
the following expression at the scattering angle θ of 18°:
20<Fy(θ)/Fx(θ)≦400
wherein Fx(θ) represents a light-scattering characteristic in the X-axis direction (MD) of the film and Fy(θ) represents a light-scattering characteristic in the Y-axis direction (CD) of the film.

9. A light-diffusing film according to claim 1, wherein the light-scattering characteristic F(θ) satisfies the following expression in the range of the scattering angle θ of 4 to 30°:
1.01≦Fy(θ)/Fx(θ)≦200
and
the following expression at the scattering angle θ of 18°:
25≦Fy(θ)/Fx(θ)≦50.

10. A light-diffusing film according to claim 1, wherein the ratio of the continuous phase relative to the dispersed phase [the continuous phase/the dispersed phase] is 99/1 to 50/50 (weight ratio).

11. A light-diffusing film according to claim 1, which further comprises a transparent layer laminated on at least one side of the light-diffusing layer, wherein the light-diffusing layer is an anisotropic light-diffusing layer which diffuses a transmitted light anisotropically.

12. A light-diffusing film according to claim 11, wherein the transparent layer is a resin layer containing at least one selected from the group consisting of an ultraviolet ray absorbing agent and a light stabilizer.

13. A light-diffusing film according to claim 1, wherein the thickness of the light-diffusing layer is 3 to 300 μm, and the total light transmittance of the film is not less than 60%.

14. A plane light source device provided with a light-diffusing film recited in claim 1.

15. A display apparatus provided with a light-diffusing film recited in claim 1.

16. A display apparatus according to claim 15, which uses a direct illumination system, in which a display unit is directly illuminated from a backside thereof with light sources disposed in parallel with each other.
